(19) United States
(12) Patent Application Publication
(10) Pub. No.: US 2003/0164968 A1
(43) Pub. Date: Sep. 4, 2003

(54) Color processing apparatus and method

(75) Inventor: Yoshiko Iida, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/370,304

(22) Filed: Feb. 18, 2003

(30) Foreign Application Priority Data
Feb. 19, 2002 (JP) 2002-041740
Apr. 30, 2002 (JP) 2002-129332
Jun. 20, 2002 (JP) 2002-180055

(51) Int. Cl. G06F 15/00; B41J 1/00

(52) U.S. Cl. 358/1.9

(57) ABSTRACT

In order to implement color conversion which makes images output using different recording sheets appear to have the same color appearance, mapping points and mapping parameters used to obtain an output gamut having a shape similar to that of the gamut of an input color space are determined on the basis of input color space information and output gamut information, and a mapping gamut used to convert an input color signal into an output color signal is generated using the mapping points and mapping parameters.

### FIELD OF THE INVENTION

The present invention relates to a color processing apparatus and method and, more particularly, to an image process for converting an input color signal into an output color signal.

### BACKGROUND OF THE INVENTION

Japanese Patent Laid-Open No. 11-136528 discloses a technique for executing color correction according to the feature of an image to be output upon converting an input color image into an image signal in an output device. That is, according to this disclosure, a photo image undergoes photo color correction, and a business document including text, a graph image, and the like undergoes graphics color correction in consideration of image quality after color correction.

A color correction process described in Japanese Patent Laid-Open No. 8-256275 aims at mapping an input color space on the gamut of a printer (such gamut will be referred to as an output gamut hereinafter). Therefore, a color conversion algorithm according to each output gamut (for each output gamut upon mapping onto a plurality of different output gamuts) is used to generate color correction parameters, thereby gamut-mapping the input color space onto the output gamut. If a color conversion result is poor, various color correction items are manually adjusted to inspect that color conversion result.

When images are output onto a plurality of different output media by a single printer, since different output media have different output gamuts, a difference in color conversion result produced by a different output gamut shape must be corrected. In this case, by making gamut mapping using appropriate correction parameters and color conversion algorithms on the basis of the relationship between the gamut of the input color space and output gamuts, color appearances reproduced by different output media can be adjusted.

An image process for making gamut mapping will be described in detail below. FIG. 22 is a schematic block diagram showing the arrangement of an image processing apparatus.

A CPU 2101 makes various kinds of control of a RAM 2103, console 2104, image processing unit 2105, monitor 2106, input device 2107, and output device 2108 in accordance with data and control programs, an operating system (OS), application programs, a color matching processing module (CMM), device drivers, and the like, which are stored in a ROM 2102.

The input device 2107 inputs color space information data of a profile to be generated, and image data read from a document or the like to the image processing apparatus. The output device 2108 outputs an image onto an output medium.

The RAM 2103 serves as a work area of the CPU 2101, and also a temporary storage area of data input from various control programs and the console 2104. The console 2104 is used to set up the output device 2108 and to input data. The image processing unit 2105 executes an image process including a profile generation process for converting an input color image into an image signal for the output device 2108 by a gamut mapping process. The monitor 2106 displays the processing result of the image processing unit 2105, data input at the console 2104, and the like. These building components are interconnected via a system bus 2109.

The profile generation process for converting an input color image into an image signal for the output device 2108 will be described below.

FIG. 23 is a block diagram showing the arrangement of the image processing unit 2105 which generates a profile to attain gamut mapping of an arbitrary input color space onto an output color space.

Building components in a profile generation unit 2201 will be explained first. Output gamut information associated with the output gamut of the output device 2108 is input from a terminal 2209, and input color space information as information associated with the gamut of the input device 2107 is input from a terminal 2210. An input gamut storage section 2204 stores the input color space information, and a printer gamut storage section 2205 stores the output gamut information. A mapping parameter calculation section 2206 calculates color space compression parameters required for a gamut mapping section 2207 with reference to the output gamut information and input color space information.

The gamut mapping section 2207 maps the gamut of the input color space onto that of the output device 2108 with reference to the input color space information and output gamut information, so as to reproduce an image having desired tone with respect to an input color signal. The output gamut of the mapping result will be referred to as a “mapping output gamut” hereinafter.

A profile generation section 2208 generates a profile used to convert RGB data into CMYK data with reference to the correspondence between the gamut of the input color space and mapping output gamut, input color information (RGB data) that represents a predetermined color on the input color space, and output color information (CMYK data) which represents a predetermined color on a printer. The generated profile is written in the RAM 2103.

On the other hand, RGB data on the image processing apparatus is input from a terminal 2211 of the image processing unit 2105, and is supplied to an interpolation section 2203. The interpolation section 2203 converts RGB data into CMYK data with reference to the profile stored in the RAM 2103, and passes the CMYK data to the output device 2108 via a terminal 2212.

The operation of the profile generation unit 2201 will be described below. In the following description, assume that the mapping operation of the profile generation unit 2201 is done in an L*a*b* color space as a uniform calorimetric system.

Initially, input color space information and output gamut information are transmitted in response to a command from the CPU 2101, and are respectively stored in the input gamut storage section 2204 and printer gamut storage section 2205.

The mapping parameter calculation section 2206 operates to calculate various parameters required for color space compression in the gamut mapping section 2207. Upon completion of the parameter calculation, the gamut mapping section 2207 operates to map the gamut of the input color space onto the output gamut.

The profile generation section 2209 generates a profile used to convert RGB data into CMYK data with reference to the mapping output gamut as a final mapping result, and writes the profile in the RAM 2103. In this way, a series of operations end.

FIG. 3 is a flow chart for explaining the mapping operation of the gamut mapping section 2207. In the following description, a continuous locus that couples a given color and another color will be referred to as a “tone curve”.

In step S301, sample points used to specify gamut mapping are determined. The sample points are categorized into surface sample points which specify a map of the gamut surface of the input color space, and internal sample points which specify a map of the interior of the gamut of the input color space. In step S302, mapping positions of the surface sample points on the output gamut are determined. Note that the mapping results of the surface sample points are not always located on the surface of the output gamut. In step S303, mapping positions of the internal sample points on the output gamut are determined. Note that the mapping results of the internal sample points are controlled to always be located inside the output gamut.

In step S304, a tone curve that couples two predetermined, different surface sample points (to be referred to as a surface tone curve hereinafter) is specified. In step S305, a mapping position of the surface tone curve on the output gamut is determined. Note that the mapping result of the surface tone curve is not always located on the surface of the output gamut.

In step S306, a tone curve that couples two predetermined, different internal sample points (to be referred to as an internal tone curve hereinafter) is specified. In step S307, a mapping position of the internal tone curve on the output gamut is determined. The mapping result of the internal tone curve is controlled to always be located inside the output gamut.

Finally, in step S308 mapping results from the gamut of the input color space to the mapping output gamut for colors required to express the mapping output gamut are acquired from the mapping results of the surface tone curve and internal tone curve.

Furthermore, upon mapping the hue of an input color signal onto an output color space using an Lab color space or LCH color space as a color space of a uniform calorimetric system in a gamut mapping process, control is made based on the hue angle in the Lab or LCH color space. Also, a color correction process in the gamut mapping process is done for the purpose of attaining one-to-one mapping between the output gamut of each output medium and the input color space gamut. This color correction process is customized so as to obtain appropriate color correction results in photo color correction and graphics color correction. In other words, a color correction process or color correction processing apparatus varies depending on the required image quality.

However, if gamut mapping is done, an image which is approximate to the color of an image of the input color space can be obtained, but output images as gamut mapping results on different output gamuts look differently. In other words, if different output media are used in a single printer, the color appearances reproduced on output images do not look the same even when an identical input image signal is used. Such nonuniformity is produced since the relationship between a pair, i.e., the gamut of the input color space and the output gamut is merely approximated, but no process for approximating the colors of output images among different output gamuts is executed in correspondence with differences among different output gamuts.

The Lab and LCH color spaces do not always match human visual characteristics. Colors which appear to be the same color depending on the lightness are not located on the same hue angle, and colors which appear to be the same color depending on the saturation are not located on the same hue angle, i.e., colors having different hues may appear to be the same color. Since color correction that uses the hue angle in the Lab or LCH color space does not consider the fact that colors having different hues often appear to be the same color, output images suffer hue differences. Especially, if output gamuts have different shapes, it is difficult for the gamut mapping process to reproduce colors so that output images appear to be the same color appearance.

Furthermore, although the basic steps of the gamut mapping process are commonly used, some parameters and mapping algorithms must be customized to acquire desired image quality. For this reason, different color correction processes or color correction apparatuses are used as well as parameters and algorithms that can be shared. For this reason, the storage capacity of a memory used to store parameters and programs required for the color correction processes increases, or color correction apparatuses corresponding in number to required color qualities are required. Hence, when the number of image qualities to be reproduced in a printer increases, the storage capacity of the memory or the number of color correction apparatuses further increases, resulting in poor efficiency.

In the color correction method compatible to a plurality of output gamuts, when the color correction result is poor, color correction parameters and the like must be manually finely adjusted. However, in such fine adjustment, since there are no guidelines for adjustment amounts, a result of adjustment for a specific parameter may impair color reproducibility associated with another parameter. In other words, only a user who is skilled in such fine adjustment can acquire an optimal image by fine adjustment.

The color appearance of an output image that has undergone color correction is optimized for a specific region. That is, color correction that assumes an output environment in Japan is optimized on the assumption that the observer is Japanese. Therefore, that output image is not always optimal to Western people, i.e., a normal observation environment in Western countries.

The aforementioned problem is largely influenced by a difference in regional color favor and difference in illumination light as one of image observation conditions. Upon examination of illumination light used upon observing an image in a home or office environment, illumination light in Western countries is normally darker than in Japan, and the illumination color is tinged with yellow or red.

As for the color favor, especially, blue, Western people normally favor blue tinged with burgundy over the blue that Japanese people like. Furthermore, Western people normally favor cold colors.

### SUMMARY OF THE INVENTION

The present invention has been made to solve the aforementioned problems individually or simultaneously, and has as its object to achieve a color conversion process which reproduces colors so that color conversion results look the same, even when output gamuts have different shapes upon color conversion for converting an input color signal into an output color signal.

In order to achieve the above object, a preferred embodiment of the present invention discloses a color processing method to convert an input signal into an output color signal, comprising the steps of:

determining mapping points and mapping parameters required to obtain an output gamut having a shape similar to a shape of an input gamut of an input color space on the basis of information of the input color space and information of the output gamut; and

generating a mapping output gamut used in color conversion using the mapping points and mapping parameters.

It is another object of the present invention to allow easy adjustment of a color conversion process.

In order to achieve the above object, a preferred embodiment of the present invention discloses a color processing method to convert an input signal into an output color signal, comprising the steps of:

determining mapping points and mapping parameters required to obtain an output gamut having a shape similar to a shape of an input gamut of an input color space on the basis of information of the input color space and information of the output gamut;

generating a mapping output gamut used in color conversion using the mapping point and mapping parameters;

forming a color conversion profile on the basis of the mapping output gamut;

evaluating a color conversion result of a predetermined evaluation color using the profile; and

correcting the mapping points within a predetermined range on the basis of the evaluation result, and re-executing generation of the mapping output gamut and generation of the profile.

It is still another object of the present invention to achieve an image process in consideration of regional characteristics.

In order to achieve the above object, a preferred embodiment of the present invention discloses a color processing method to convert an input signal into an output color signal, comprising the steps of:

acquiring regional information indicating an observation environment of an output image;

acquiring information associated with color spaces of image input and output devices;

generating color processing parameters on the basis of the regional information and information associated with the color space; and

forming a profile used to convert an input color signal into an output color signal using the generated color processing parameters.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the arrangement of a computer apparatus which implements an image process of an embodiment;

FIG. 2 is a block diagram showing the arrangement of an image processing unit;

FIG. 3 is a flow chart for explaining a mapping operation of a gamut mapping section;

FIG. 4 is a block diagram showing the arrangement for determining mapping parameters;

FIG. 5 is a flow chart showing a process to be executed by a profile generation unit;

FIG. 6 is a flow chart for explaining a switching operation of mapping point calculation processes on the basis of image design guideline data;

FIG. 7 is a flow chart for explaining a switching operation of mapping control parameter calculation processes on the basis of image design guideline data;

FIG. 8 is a block diagram showing the arrangement for implementing gamut mapping;

FIG. 9 is a flow chart showing a switching operation of mapping algorithms on the basis of image design guideline data;

FIG. 10 is a sectional view of two output gamuts having different shapes, which are divided at a given lightness level in an HVC color space;

FIG. 11 is a flow chart showing a mapping process of an embodiment;

FIG. 12 is a graph showing the distribution of surface sample points on an input color space;

FIGS. 13A and 13B are graphs showing the relationship between the input and output gamuts;

FIG. 14 is a graph showing the setting results of mapping lightness levels corresponding to respective surface sample points;

FIG. 15 is a graph showing the calculation result of iso-hue curve information;

FIG. 16 is a flow chart showing details of a mapping objective hue range;

FIG. 17 is a graph showing the adjusted output gamut, the output gamut before adjustment, and the input gamut;

FIG. 18 is a graph showing the mapping result in the adjusted color gamut;

FIG. 19 shows the configuration of a target hue value memory;

FIG. 20 shows an example of an intersection coordinate storage area;

FIG. 21 shows an example of an iso-hue curve information storage area;

FIG. 22 is a schematic block diagram showing the arrangement of an image processing apparatus;

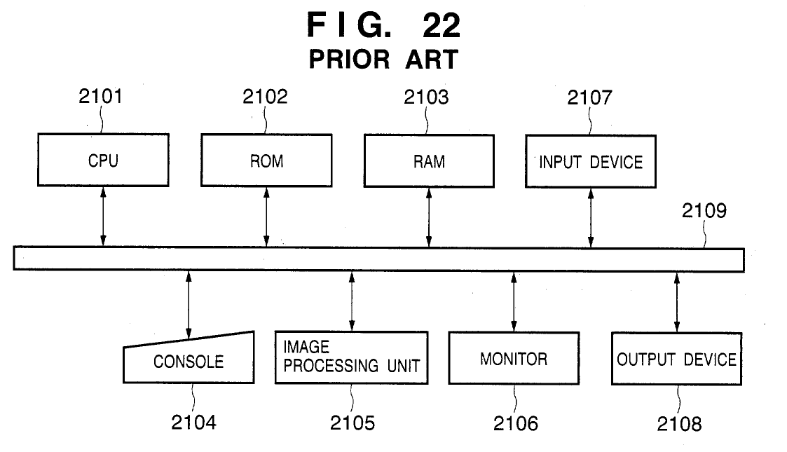

FIG. 23 is a block diagram showing the arrangement of an image processing unit, which generates a profile, and gamut-maps an arbitrary input color space onto an output color space;

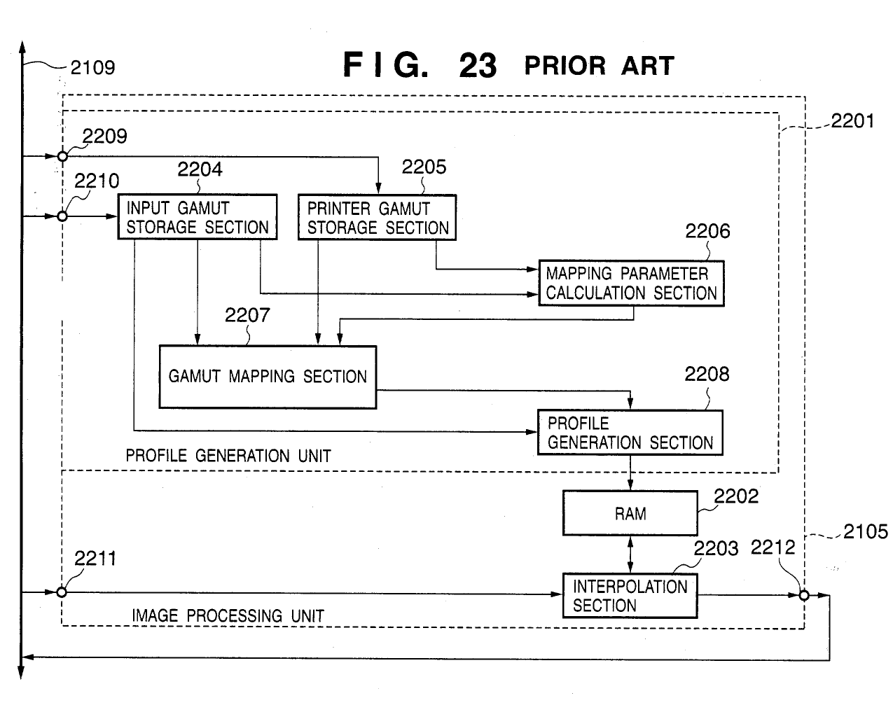

FIG. 24 is a block diagram showing the detailed arrangement of the image processing unit;

FIG. 25 shows an example of mapping/evaluation reference data;

FIG. 26 is a flow chart showing a setting process of mapping control parameters;

FIG. 27 shows the relationship between the target hue value and allowable range of a hue evaluation color;

FIG. 28 is a block diagram showing the detailed arrangement of an evaluation section;

FIG. 29 shows an example of data stored in an evaluation objective color memory;

FIG. 30 shows an example of data stored in evaluation objective color & target/allowable coordinate memory;

FIG. 31 is a flow chart showing an evaluation process of color reproducibility;

FIG. 32 is a flow chart showing an allowable range inside/outside checking process and a process for obtaining an evaluation value;

FIG. 33 shows the relationship among the allowable range, evaluation objective color, and target color;

FIG. 34 shows an example of data stored in an evaluation value storage memory;

FIG. 35 is a flow chart showing a profile generation process;

FIG. 36 is a flow chart showing a profile correction process;

FIG. 37 is a block diagram showing an example of the arrangement of an image processing unit;

FIG. 38 shows an example of an image design parameter table; and

FIG. 39 is a flow chart showing the flow of processes in the image processing unit.

### DESCRIPTION OF THE PREFERRED EMBODIMENTS

An image processing apparatus according to an embodiment of the present invention will be described in detail hereinafter with reference to the accompanying drawings.

First Embodiment

[Arrangement]

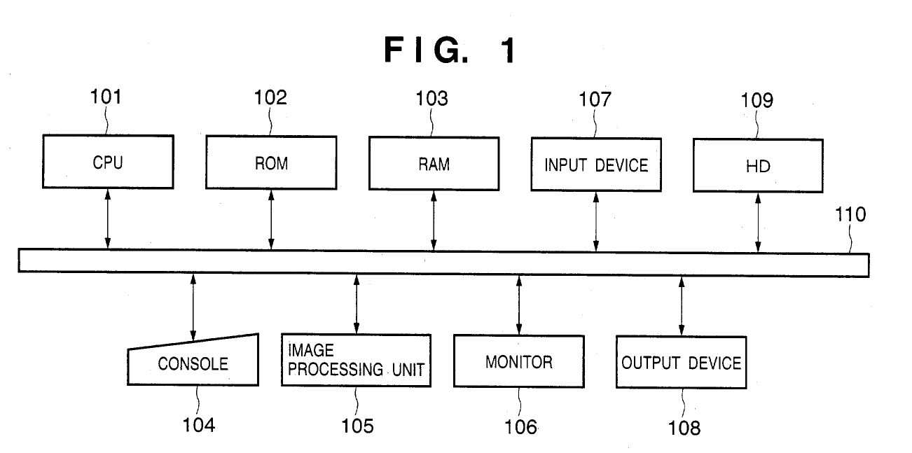

FIG. 1 is a block diagram showing the arrangement of a computer apparatus (to be referred to as a “host computer” hereinafter) that executes an image process of this embodiment.

A CPU 101 executes various kinds of control and processes by controlling a RAM 103, console 104, image processing unit 105, monitor 106, input device 107, and output device 108 in accordance with data and control programs, an operating system (OS), application programs (AP), a color matching processing module (CMM), device drivers, and the like, which are stored in a ROM 102 and hard disk (HD) 109.

The RAM 103 serves as a work area used by the CPU 101 to execute various control programs, and also a temporary storage area of data input from the console 104 and the like.

The input device 107 corresponds to an image input device such as an image scanner, digital camera, or the like, which includes a CCD or CMOS sensor, or a calorimetric device, and inputs color space information data used to generate an arbitrary profile, and image data read from a document or the like to the host computer.

The output device 108 corresponds to an ink-jet printer, thermal-transfer printer, wire-dot printer, laser beam printer, or the like, and forms and outputs a color image onto a recording sheet (output medium).

The console 104 includes a mouse, keyboard, and the like, and is used by the user to input operation conditions of the input device 107 and output device 108, setup data of various conditions of image processes, and the like.

The image processing unit 105 is a function expansion card which comprises hardware such as an ASIC, DSP, and the like, and executes various image processes that include a setup process of tone point information, and a generation process of a profile by a gamut mapping process using the set tone point information. If the CPU 101 has high performance, and the RAM 103 and HD 109 can assure sufficiently high access speeds, the same results can be obtained by executing programs corresponding to image processes to be described later using the CPU 101, RAM 103, and HD 109, without preparing any special function expansion card as the image processing unit 105.

The monitor 106 comprises a CRT, LCD, or the like, and displays an image processing result, a user interface window upon operation at the console 104, and the like.

Note that the console 104, monitor 106, input device 107, output device 108, and HD 109 are connected to a system bus 110 of the host computer via predetermined interfaces, although not shown in FIG. 1.

[Image Processing Unit]

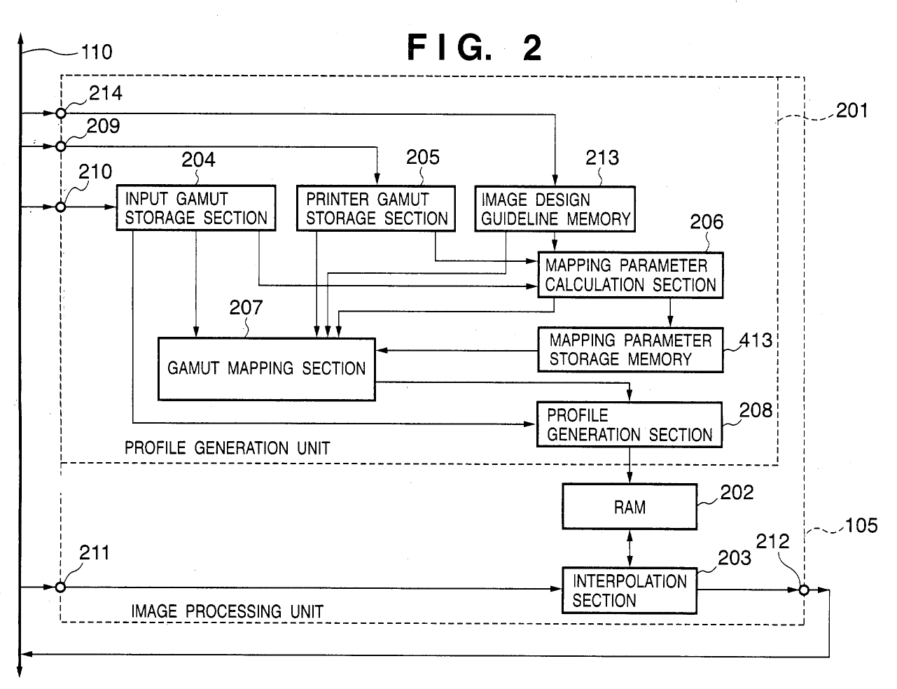

FIG. 2 is a block diagram showing the arrangement of the image processing unit 105.

A mapping parameter calculation section 206 in a profile generation unit 201 shown in FIG. 2 is connected to an image design guideline memory 213, which stores parameters and algorithms used to execute a process that makes color conversion results for an input color signal appear the same even when output gamuts have different shapes, and parameters and algorithms required for a color correction process that realizes desired image quality (these parameters and algorithms will be collectively referred to as “image design guideline data” hereinafter), as some of its functions. The image design guideline memory 213 is connected to the host computer (or a network) via a terminal 214, and can load and store image design guideline data that can realize desired image quality. Alternatively, the image design guideline memory 213 may store a plurality of image design guideline data, which are switched in response to a user's instruction input via the terminal 214, so as to implement a color correction process of user's choice.

Arrangement for Determining Mapping Control Parameters

A mapping parameter calculation section 206 generates mapping parameters required for a mapping process that realizes desired image quality, on the basis of image design guideline data stored in the image design guideline memory 213. Note that a processing algorithm used to realize desired image quality on an output gamut in correspondence with an input gamut, and a mapping parameter generation algorithm to be shared or a mapping parameter generation algorithm which may be used frequently, are pre-stored in a mapping point determination program memory 408 and mapping parameter generation program memory 409 (to be described later). The processes implemented by these algorithms will be referred to as a “normal mapping point determination process” hereinafter.

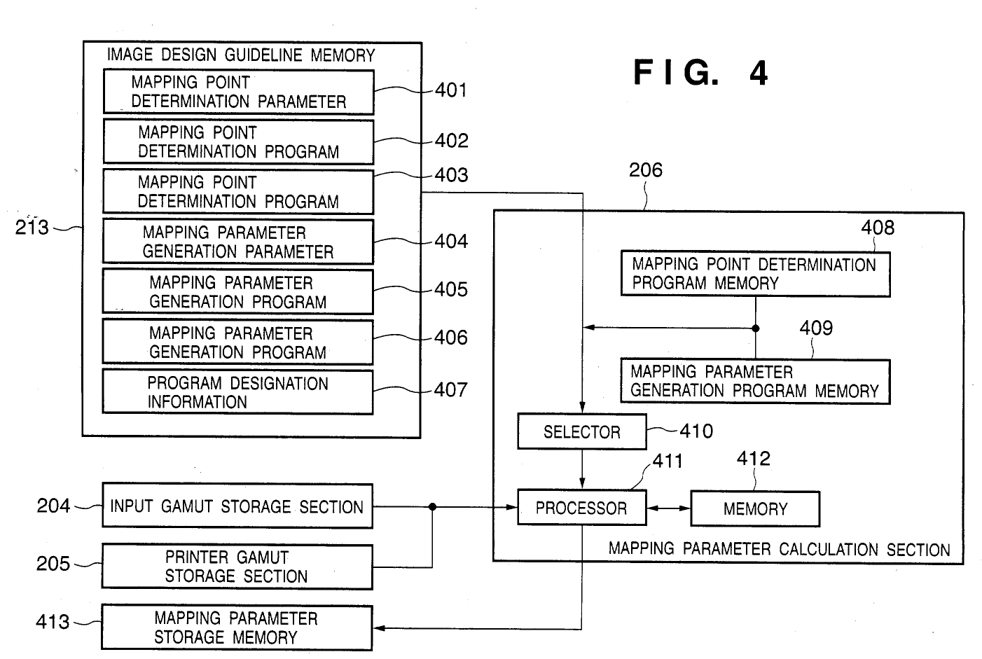

FIG. 4 is a block diagram showing the arrangement for determining mapping parameters.

The image design guideline memory 213 stores data used to calculate parameters which are required to execute a gamut mapping process that makes color conversion results appear the same even when output gamuts have different shapes, and data used to calculate parameters that realize desired image quality, upon calculation of mapping parameters. Note that these data indicate coordinates of mapping points corresponding to surface sample points, tone characteristic control information of an output image, color space compression parameters used to map internal sample points, and the like in the gamut mapping process, and will be referred to as “mapping control parameters” hereinafter.

The image design guideline memory 213 stores mapping point determination parameters 401 and mapping point determination programs 402 and 403 as parameters and algorithms used to determine mapping points corresponding to surface sample points, which absorb shape differences of output gamuts. Likewise, the memory 213 stores mapping parameter generation parameters 404, mapping parameter generation programs 405 and 406, and the like, which are used to calculate mapping parameters for determining mapping points corresponding to surface and internal sample points from input color space information and output gamut information. Of course, the numbers of parameters, programs, and algorithms are not particularly limited. Program designation information 407 stored in the image design guideline memory 213 is used to manage a parameter generation process in the mapping parameter calculation section 206. Upon receiving the program designation information 407, the mapping parameter calculation section 206 executes the parameter generation process by reading out programs and parameters stored in the image design guideline memory 213 as needed.

The mapping parameter calculation section 206 stores mapping parameter generation algorithms and parameters used for the normal mapping point determination process in a mapping point determination program memory 408 and mapping parameter generation program memory 409. Upon reception of a determination instruction of mapping points and mapping control parameters, the mapping parameter calculation section 206 reads out input color space information from an input gamut storage section 204, reads out output gamut information from a printer gamut storage section 205, and stores them in a memory 412.

In case of the normal mapping point determination process, the mapping parameter calculation section 206 appropriately selects a program stored in the mapping point determination program memory 408 or mapping parameter generation program memory 409 to execute a process. However, upon receiving the program designation information 407, the section 206 selects a mapping point determination program or mapping parameter generation program stored in the image design guideline memory 213 to execute a process. These programs are selected by a selector 410, and are supplied to a processor 411. The processor 411 stores, in a mapping parameter storage memory 413, mapping control parameters, which are calculated by setting mapping points with reference to the input color space information and output gamut information stored in the memory 412.

Calculation of Mapping Control Parameters

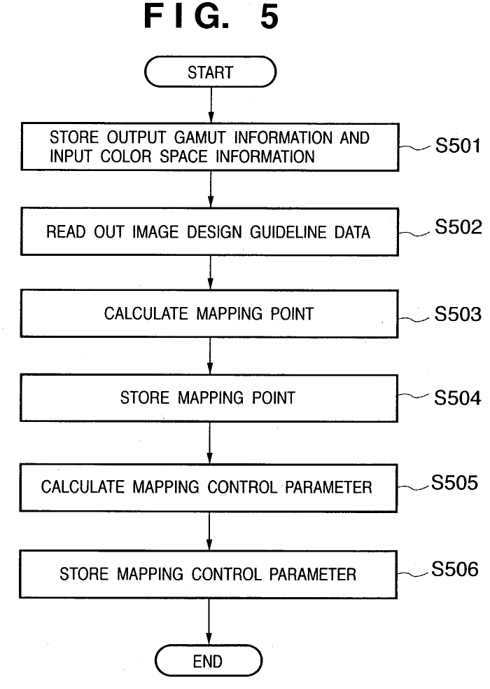

The process to be executed by the profile generation unit 201 on the basis of image design guideline data stored in the image design guideline memory 213 will be described below using the flow chart shown in FIG. 5.

In step S501, input color space information and output gamut information are respectively stored in the input gamut storage section 204 and printer gamut storage section 205.

In step S502, image design guideline data stored in the image design guideline memory 213 is read out. If a plurality of image design guideline data are stored, one of these data is selected in accordance with a user's instruction input at the console 104.

In step S503, on the basis of the input color space information and output gamut information, mapping points designated by the image design guideline data are calculated, and those required for a mapping process are calculated using the normal mapping point determination process, in correspondence with sample points on an input gamut. In step S504, the calculated mapping points are stored in the mapping parameter storage memory 413.

In step S505, on the basis of the input color space information and output gamut information, mapping control parameters designated by the image design guideline data are calculated, and those required for a mapping process are calculated using the normal mapping point determination process. In step S506, the calculated mapping control parameters are stored in the mapping parameter storage memory 413.

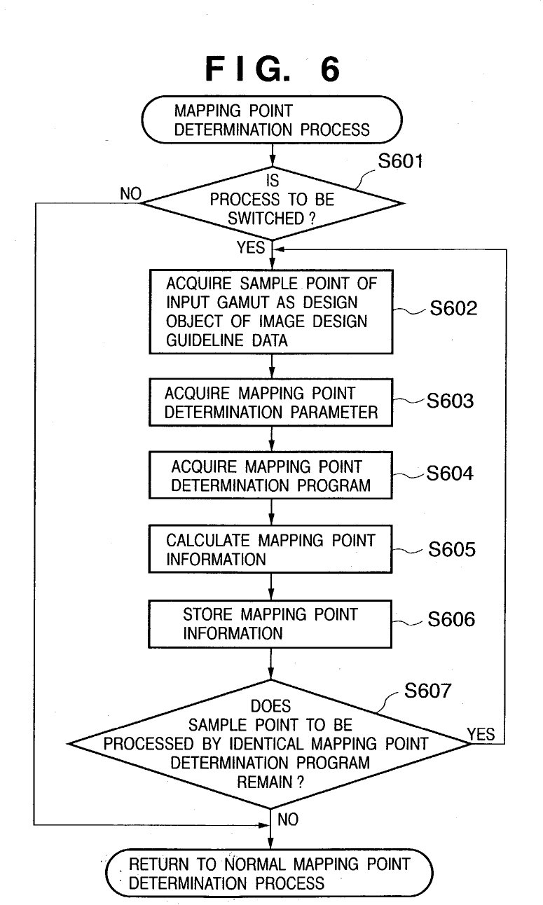

A switching operation of mapping point calculation processes based on image design guideline data will be explained below with reference to the flow chart shown in FIG. 6.

The flow chart shown in FIG. 6 shows that the mapping points calculated in step S503 are classified into those calculated by the normal mapping point determination process, and those calculated by an algorithm designated by the image design guideline data. FIG. 6 explains the process for calculating mapping points using a mapping point generation algorithm designated by the image design guideline data in detail.

It is checked in step S601 if a generation algorithm change instruction is input by the program designation information 407 upon calculating a given mapping point. If no generation algorithm change instruction is input, mapping points are determined by the normal mapping point determination process. On the other hand, if the generation algorithm change instruction is input, a sample point corresponding to a mapping point to be calculated is acquired from the image design guideline data in step S602. This sample point is that on an input gamut as a design object of the image design guideline data.

In step S603, mapping point determination parameters 401 are acquired from the image design guideline data. In step S604, a mapping point determination program 402 or 403 corresponding to a generation algorithm is acquired from the image design guideline data. In step S605, mapping point information such as the coordinate position of the mapping point and the like corresponding to the sample point acquired in step S602 is calculated on the basis of the acquired mapping point determination parameters 401 and mapping point determination program 402 or 403.

In step S606, the calculated mapping point information is stored in the mapping parameter storage memory 413 in correspondence with the sample point acquired in step S602. It is checked in step S607 if sample points to be processed by the same mapping point determination program still remain. If such sample points remain, the flow returns to step S602; otherwise, the flow returns to the normal mapping point determination process.

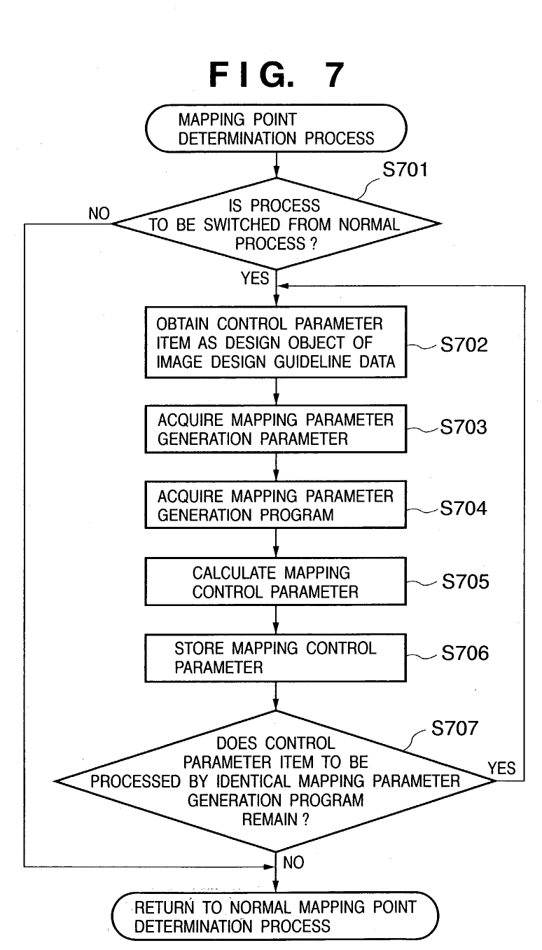

A switching operation of mapping control parameter calculation processes based on image design guideline data will be explained below with reference to the flow chart shown in FIG. 7.

The flow chart shown in FIG. 7 shows that the mapping control parameters calculated in step S505 are classified into those calculated by the normal mapping point determination process, and those calculated by an algorithm designated by the image design guideline data. FIG. 7 explains the process for calculating mapping control parameters using a generation algorithm of mapping control parameters designated by the image design guideline data in detail.

It is checked in step S701 if a generation algorithm change instruction is input by the program designation information 407 upon calculating a given mapping control parameter. If no generation algorithm change instruction is input, mapping control parameters are determined by the normal mapping point determination process. On the other hand, if the generation algorithm change instruction is input, a control parameter item as a design object of the image design guideline data, which corresponds to a mapping control parameter to be calculated, is acquired from the image design guideline data in step S702.

In step S703, mapping parameter generation parameters 404 are acquired from the image design guideline data. In step S704, a mapping parameter generation program 405 or 406 corresponding to a generation algorithm is acquired from the image design guideline data. In step S705, a mapping control parameter corresponding to the control parameter item acquired in step S702 is calculated using the acquired mapping parameter generation parameters 404 and mapping parameter generation program 405 or 406.

In step S706, the calculated mapping control parameter is stored in the mapping parameter storage memory 413 in correspondence with the control parameter item. It is checked in step S707 if control parameter items to be processed by the same mapping parameter generation program still remain. If such control parameter items remain, the flow returns to step S702; otherwise, the flow returns to the normal mapping point determination process.

With the aforementioned processes, mapping points and mapping control parameters, which realize desired image quality on an output gamut in correspondence with an input gamut, and absorb an output gamut difference, are determined by the normal mapping point determination process, and the mapping point determination process based on the image design guideline data.

Arrangement for Implementing Gamut Mapping

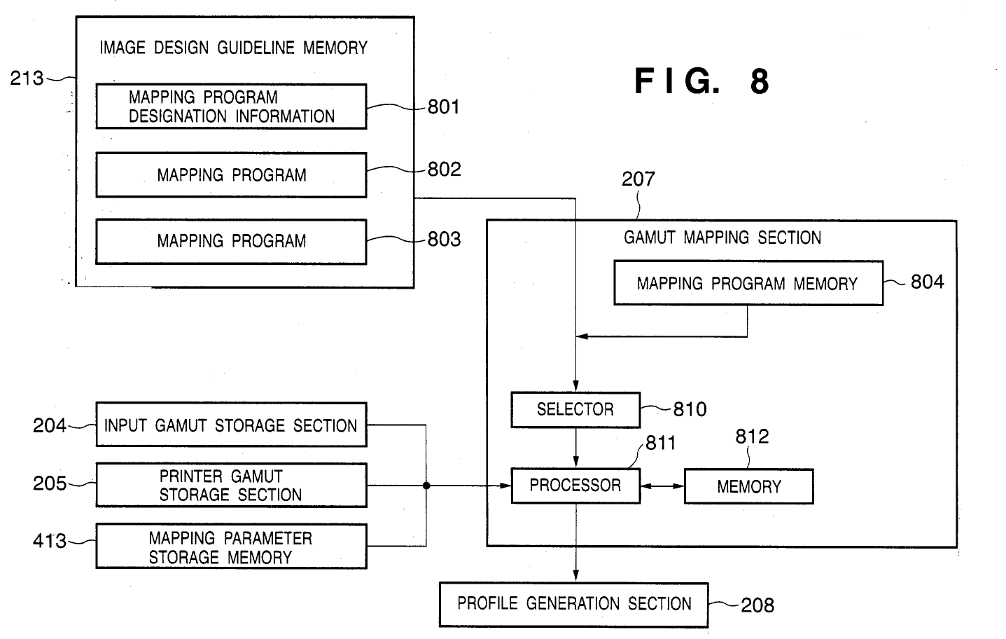

FIG. 8 is a block diagram showing the arrangement for implementing gamut mapping.

In a gamut mapping section 207, a mapping algorithm used to realize desired image quality on an output gamut in correspondence with an input gamut, and a mapping algorithm to be shared or a mapping algorithm which may be used frequently, are pre-stored in a mapping program memory 804. The processes implemented by these algorithms will be referred to as a “normal gamut mapping process” hereinafter.

The image design guideline memory 213 stores mapping programs 802 and 803 of algorithms, which are used to execute gamut mapping processes that make the color conversion results of an input color signal appear the same even when output gamuts have different shapes, using the calculated mapping point information and mapping control parameters. Note that the number of mapping programs stored in the image design guideline memory 213 is not limited.

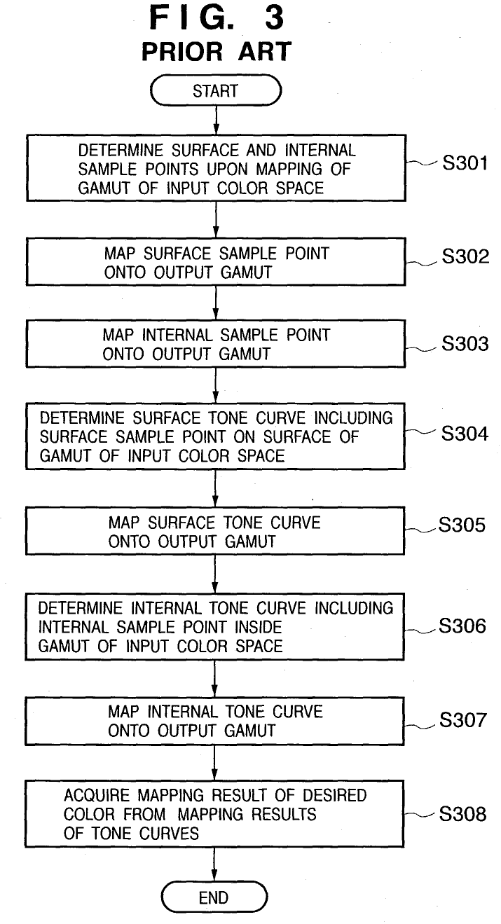

A mapping program stored in the mapping program memory 804 in the gamut mapping section 207 executes a mapping process to mapping points corresponding to surface sample points, a process for determining mapping points of sample points on the basis of tone characteristic control information of an image to be output, and a process for determining mapping points of internal sample points on the basis of the surface sample points and color space compression parameters, in the gamut mapping process shown in FIG. 3.

Mapping program designation information 801 stored in the image design guideline memory 213 is used to manage a mapping process in the gamut mapping section 207. Upon receiving the mapping program designation information 801, the gamut mapping section 207 executes the mapping process by reading out a mapping program stored in the image design guideline memory 213 as needed.

Upon reception of an execution instruction of a gamut mapping process, the gamut mapping section 207 reads out input color space information from the input gamut storage section 204, and reads out output gamut information from the printer gamut storage section 205. The section 207 then stores them in a memory 812. The gamut mapping section 207 executes a process based on a mapping program stored in the mapping program memory 804. Upon receiving the mapping program designation information 801, the section 207 selects a mapping program stored in the image design guideline memory 213 to execute a process. These mapping programs are selected by a selector 810, and are supplied to a processor 811. The processor 811 executes a gamut mapping process with reference to the input color space information and output gamut information stored in the memory 812, and the mapping point information and mapping control parameters stored in the mapping parameter storage memory 413. The processor 811 sends the mapping result to a profile generation section 208 to make it generate a profile.

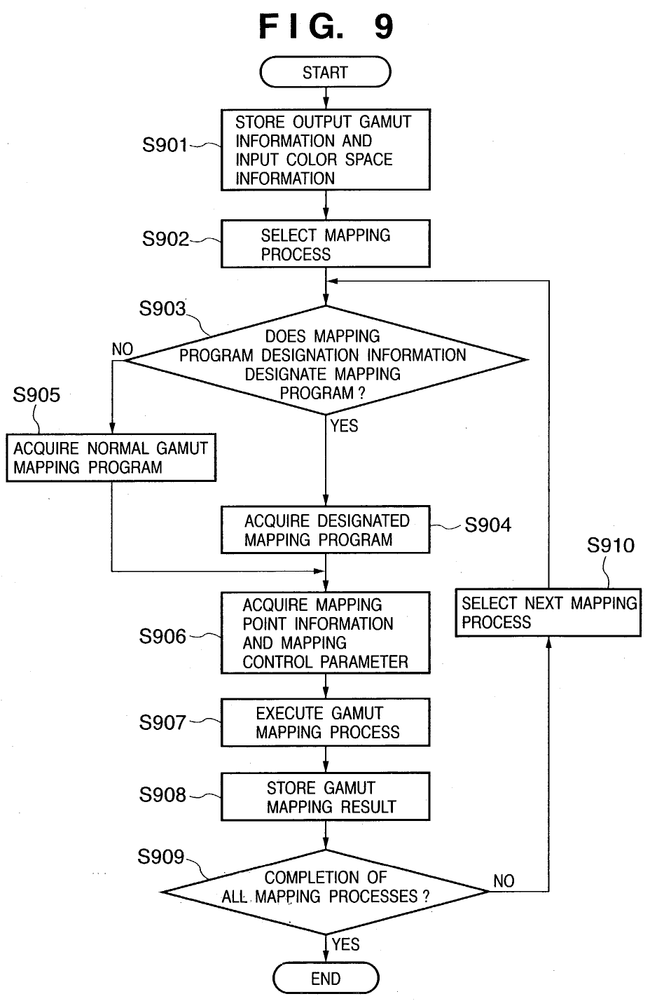

The gamut mapping section 207 executes the normal gamut mapping process according to the steps that have been explained using the flow chart of FIG. 3, and that based on image design guideline data. A switching operation of mapping algorithms based on image design guideline data will be explained below with reference to the flow chart of FIG. 9.

In step S901, input color space information and output gamut information are respectively stored in the input gamut storage section 204 and printer gamut storage section 205.

In step S902, the mapping process that has been explained using the flow chart in FIG. 3 is selected.

It is checked in step S903 if a mapping program is designated by the mapping program designation information 801, before the beginning the mapping process. If the mapping program is designated, the designated mapping program is read out from the image design guideline memory 213 in step S904. On the other hand, if no mapping program is designated, a mapping program for the normal gamut mapping process, which is stored in the mapping program memory 804, is read out in step S905.

In step S906, mapping point information and mapping control parameters required to execute the acquired mapping program are read out from the mapping parameter storage memory 413, and are stored in the memory 812. In step S907, the gamut mapping process is executed on the basis of the acquired mapping program, mapping control parameters, and mapping point information. In step S908, the gamut mapping result is temporarily stored in the memory 812.

It is checked in step S909 if all mapping processes are complete. If mapping processes to be executed still remain, the next mapping process is selected (steps S303, S305, and S307 are selected in turn) in step S910 to repeat the processes in step S903 and the subsequent steps in step S910. If all mapping processes are complete, the gamut mapping result stored in the memory 812 is sent to the profile generation section 208.

In this way, the mapping parameter calculation section 206 and gamut mapping section 207 execute the gamut mapping process that make the color conversion results of an input color signal appear the same even when output gamuts have different shapes. The image design guideline memory 213 stores, as image design guideline data, data used to generate parameters required for that gamut mapping process, data used to generate parameters required to realize desired image quality, mapping programs, and the like.

Note that there are various mapping point determination processes, mapping parameter determination processes, and mapping algorithms, which make the color conversion results of an input color signal appear the same, in correspondence with image design guideline data. However, means and algorithms to be used are not particularly limited as long as they are adaptive to the arrangement of the embodiment. Of course, the types of image quality to be realized by the image design guideline data is not particularly limited as long as they are adaptive to the arrangement of the embodiment.

[Mapping Process Example]

An example of the mapping process which makes the color conversion result of an input color signal appear the same will be described in detail below. Note that the determination processes of mapping points and mapping control parameters designated by image design guideline data, and the selection process of a mapping algorithm are mixed in the following description, but all these processes are those based on the image design guideline data unless otherwise specified. Hence, assume that normal processes are switched to the processes based on the image design guideline data, and these processes are executed in the aforementioned arrangement of the image processing apparatus.

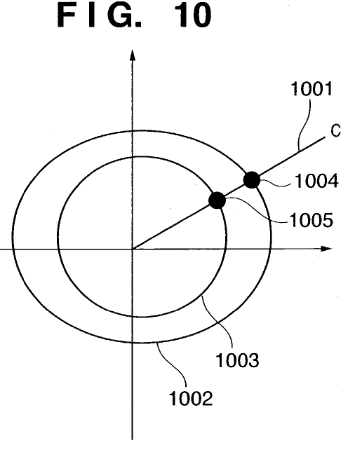

FIG. 10 is a sectional view of two output gamuts 1002 and 1003 having different shapes, which are divided at a given lightness level in an HVC color space as a coordinate system which represents the distribution of colors at equal intervals of human visual perception. In the HVC color space, chromaticity points on an iso-hue curve 1001 of given hue H are perceived as the similar color by human visual perception. Hence, intersections 1004 and 1005 between the iso-hue curve 1001 and the output gamuts 1002 and 1004 visually appear to have the similar color appearance, although they reproduce different saturation levels. Hence, in this embodiment, colors which present the same color appearance even in different output gamuts are acquired on the basis of iso-hue curve information in the HVC color space.

Hue H of a mapping point on an output gamut is a hue value on the HVC space as a coordinate system which represents the distribution of colors at equal intervals of human visual perception, and must undergo coordinate conversion (mapping process) to an Lab space as a representation coordinate system of the output gamut.

In such mapping process, the image design guideline data designates, as parameters used to determine mapping control parameters, special values like coordinate values in the HVC space as a different color space in place of values in the Lab space which are used in the normal gamut mapping process. For this purpose, an algorithm for implementing coordinate conversion between the coordinate values in the HVC space and the Lab space is pre-stored in the image design guideline data. Therefore, upon generating mapping control parameters, the color space conversion algorithm and required conversion information are read out from the image design guideline data to execute color space conversion.

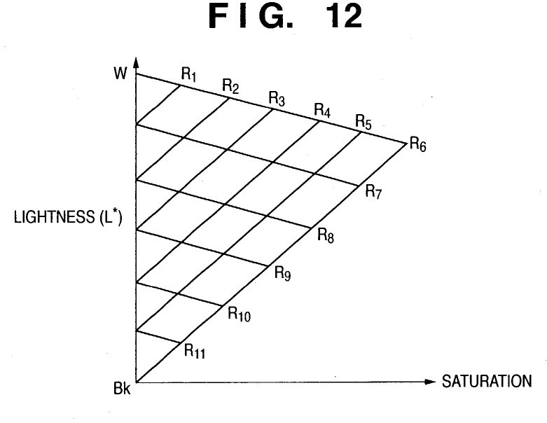

FIG. 12 shows the distribution of surface sample points on an RGB color space which is assumed to be an input color space, taking a Red (R) plane as an example. FIG. 12 shows a cross-sectional plane obtained by cutting the gamut of the RGB color space by a plane that passes through three points white (W), red (R), and black (Bk). In FIG. 12, an upper left point indicates white point W(255, 255, 255), and a lower left point indicates black point Bk(0, 0, 0). The ordinate indicates a gray axis which changes from (0, 0, 0) to (255, 255, 255) on the (R, G, B) coordinate system. Also, Ri (i=1 to 11) represents a surface sample point on the R plane, and indices i are assigned to sample points in descending order of lightness (R₆ corresponds to red). Note that index numbers are assigned to sample points on green (G), blue (B), cyan (C), magenta (M), and yellow (Y) planes as in the above R plane.

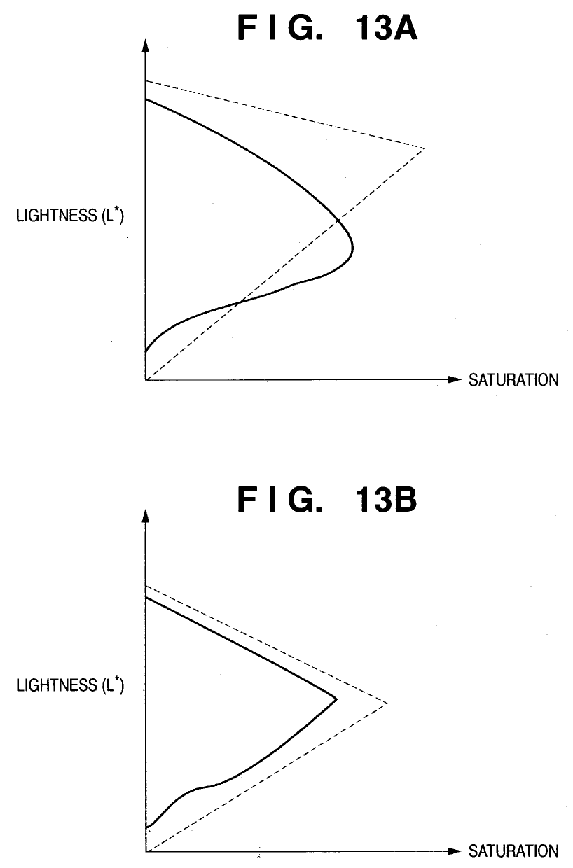

FIG. 13A is a graph that shows the R plane (broken curve) shown in FIG. 12, which is superposed on an R plane (solid curve) of an output gamut when a certain output medium is used. On the other hand, FIG. 13B is a graph that shows the R plane in FIG. 12, which is superposed on an R plane of another output gamut when an output medium different from FIG. 13A is used. In this manner, the output gamuts have different shapes depending on output media, and whether or not the output gamut shape is approximate to that of the input gamut largely influences the gamut mapping result.

The following processes may be added as the gamut mapping process which can make color conversion results of an input color signal appear similarity in different output gamuts.

(1) The sections of output gamuts at six hues of Red, Green, Blue, Cyan, Magenta, and Yellow (these six colors will be referred to as primary colors hereinafter) undergo a color space compression process, which can obtain a mapping output gamut, the shape of which is similar to that of the input gamut as much as possible. In the following description, to obtain a similar shape as much as possible is expressed by “approximate”.

(2) Upon determining mapping points on lines that connect white—primary color—black, the shape of an output gamut is adjusted by adjusting the color appearance of an output color using an HVC color space value, and gamut mapping is executed using the adjusted output gamut.

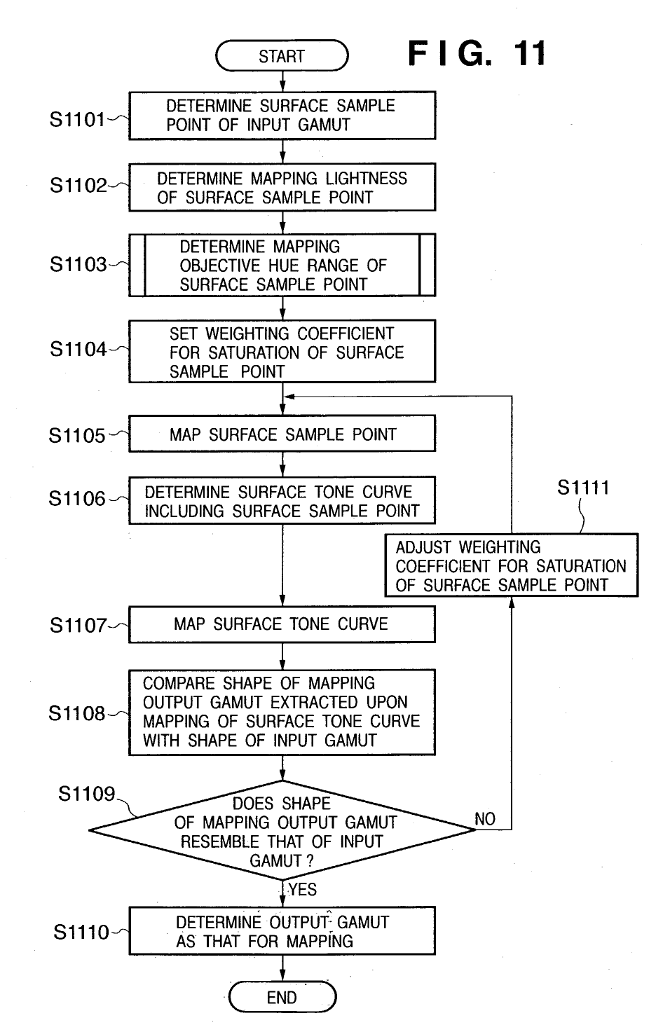

FIG. 11 is a flow chart showing the mapping process of this embodiment. In this case, a mapping process on the R plane shown in FIG. 12 will be exemplified, and the same process is executed for the G, B, C, M, and Y planes.

In step S1101, surface sample points on white-red-black lines of an input gamut are determined. In this case, R₁ to R₁₁ are set as surface sample points on the R plane.

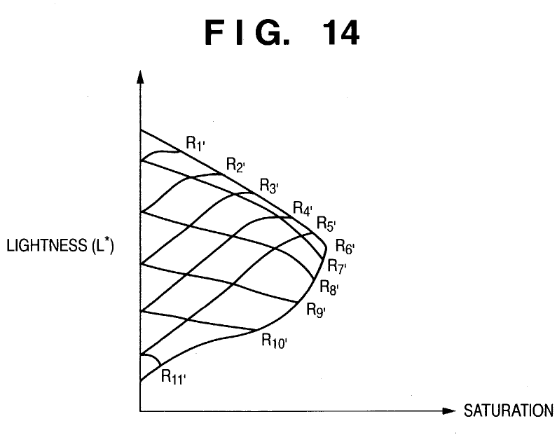

In step S1102, lightness levels to be mapped of the surface sample points are determined. As shown in FIGS. 13A and 13B, since the total lightness of the output gamut is different from that of the input gamut, lightness (mapping lightness) levels used to map the respective surface sample points are set in correspondence with those on the output gamut. FIG. 14 shows the setting results (R₁ to R₁₁) of mapping lightness levels corresponding to the respective surface sample points.

In step S1103, as for hues of mapping points of the surface sample points, a mapping objective hue range (iso-hue curve information) on the output gamut is set on the basis of the set mapping lightness levels or on the basis of hue values on the HVC color space, which are defined in advance in the image design guideline data for Red hue. Details of the process in step S1103 will be described later.

In step S1104, as for the saturation levels of mapping points of the surface sample points, weighting coefficients of mapping points in the saturation direction, which set an outermost edge point of the output gamut in the mapping objective hue range to be “1”, are determined. Note that the default value of the weighting coefficient may be “1” corresponding to the outermost edge point. The surface sample points are mapped onto the mapping object hue range corresponding to the mapping lightness levels in accordance with the weighting coefficients.

In step S1105, the surface sample points are mapped. In step S1106, a surface tone curve that includes the surface sample points is defined on the surface of the input gamut. In step S1107, the surface tone curve is mapped to include the mapping points in step S1105.

In step S1108, the shape of an R plane of a mapping output gamut extracted upon mapping the surface tone curve is compared with that of the input gamut. The area of an output gamut, which is given away from the original output gamut upon adjustment of the output gamut, is checked to obtain the area to be given away, and the shapes of the mapping output gamut and input gamut are compared to obtain the degree of approximation of the shapes. Then, it is checked in step S1109 using them as criteria if the mapping output gamut is appropriate.

If it is determined that the mapping output gamut is inappropriate, the weighting coefficients of saturation levels of the respective surface sample points are adjusted in step S1111 so that the shape of the mapping output gamut is approximate to that of the R plane of the input gamut. After that, the processes in step S1105 and subsequent steps are repeated. If it is determined that the mapping output gamut is appropriate, i.e., that the shape of the mapping output gamut is sufficiently approximate to that of the R plane of the input gamut, the mapping output gamut is set as a gamut for mapping in step S1110.

The shape of a mapping output gamut obtained by executing the aforementioned process at least for primary color (Red, Green, Blue, Cyan, Magenta, and Yellow) planes is sufficiently approximate to that of the input gamut. Therefore, even when different output media have different output gamut shapes, a mapping output gamut sufficiently approximate to the input gamut can be obtained, and at least the hues of the primary colors are mapped to chromaticity points of color appearances, which appear to be the same by human visual perception, on the basis of the HVC color space.

Therefore, since the color appearances of mapping points of at least the primary colors are approximate to the mapping output gamut which is sufficiently approximate to the input gamut, and other mapping points are determined with reference to previously mapped chromaticity points, even when other sample points of the input gamut undergo the normal mapping point determination process and normal gamut mapping process, the color conversion results obtained using different output media (output gamuts of different shapes) can be adjusted to have uniform color reproducibility.

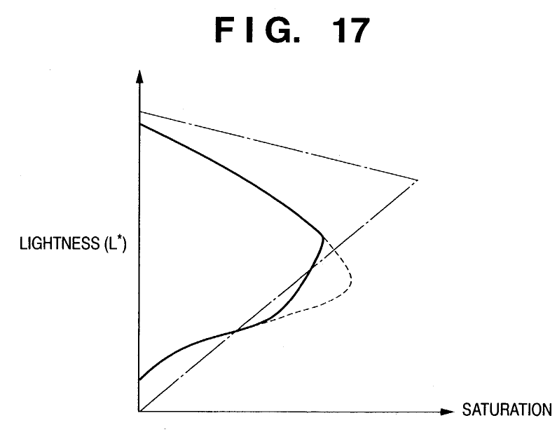

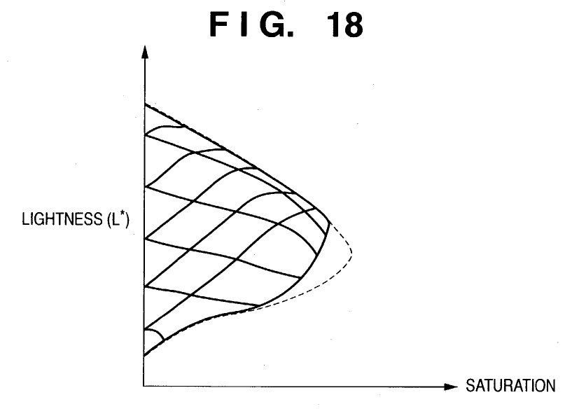

FIG. 17 shows the output gamut (solid curve) adjusted by the above process, the output gamut (broken curve) before adjustment, and the input gamut (one-dashed chain curve). FIG. 18 shows the mapping result on the adjusted output gamut.

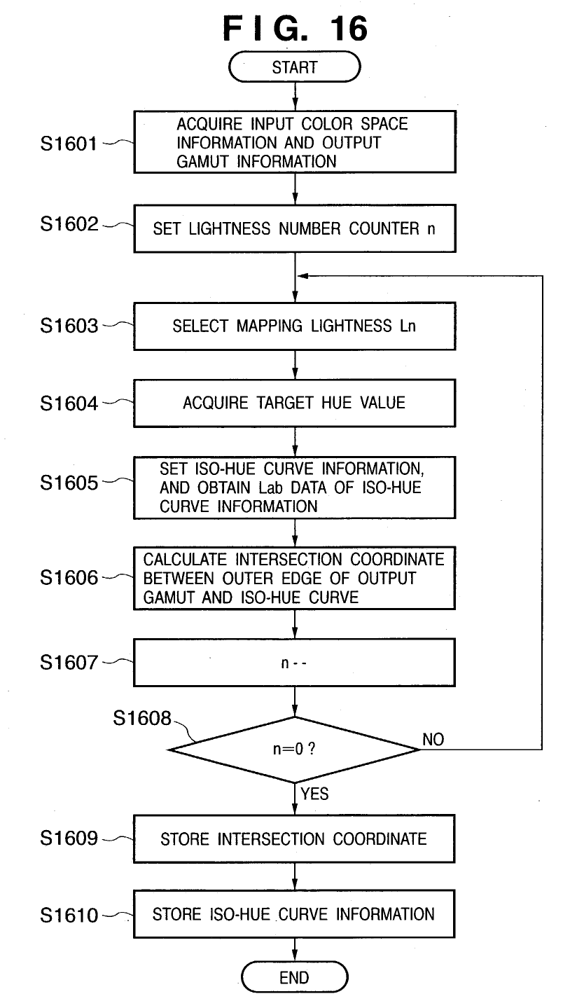

FIG. 16 is a flow chart showing details of the setup process of the mapping objective hue range in step S1103. The process in step S1103, which sets the mapping objective hue range (iso-hue curve information) on the output gamut for hues of mapping points of the surface sample points, on the basis of the mapping lightness levels set for the surface sample points or the hue values on the HVC color space defined in advance in the image design guideline data for hues of the surface sample points, will be described in detail below. In FIG. 16, L₁ to L₁₁ represent mapping lightness levels corresponding to the surface sample points R₁ to R₁₁ for the R plane of the output gamut.

In step S1601, input color space information and output gamut information are acquired. In step S1602, lightness level counter n used to set iso-hue curve information is set (in this embodiment, n=11 is set in correspondence with L₁ to L₁₁). In step S1603, mapping lightness level Lₙ is selected. In step S1604, target hue value of the surface sample point at mapping lightness level Lₙ is acquired.

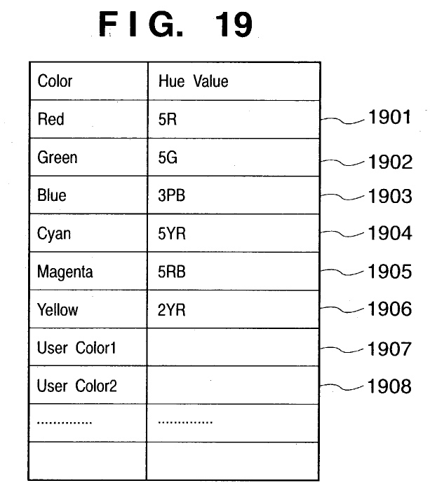

The target hue value is pre-stored in the image design guideline data, and color-dependent hue information is set in a memory area show in FIG. 19. FIG. 19 shows the configuration of a target hue value memory. Memory areas 1901 to 1906 that store color-dependent hue information pre-store predetermined target hue values when the primary colors (Red, Green, Blue, Cyan, Magenta, and Yellow) are designated as sample points. The target hue values are hue values on the HVC color space which makes uniform lightness, hue, and saturation changes with respect to the human eye. In this case, each target hue value is indicated by a hue value on the Munsell notation color space. Assume that mapping points of surface sample points Ri which shift along the W-R₆-Bk lines shown in FIG. 12 have the same hue (mapping hue), for the sake of simplicity. Of course, even when mapping hues for Ri are different from each other, a hue which is suitable for realizing appropriate image quality at a given mapping lightness level may be held as a target hue value in correspondence with index i in the memory area which stores color-dependent hue information, as shown in FIG. 19.

In step S1604, a Munsell hue value “5R” as the designated hue value of Red is read out from the memory area 1901, and is acquired as the target hue value. In this embodiment, the Munsell notation color space is defined as the HVC space to obtain an iso-hue curve for each lightness level, the image design guideline data stores information which defines the correspondence between coordinate points of the Munsell notation color space and Lab color space, and iso-hue curve information for each mapping lightness level is set based on the target hue value and mapping lightness level.

Note that the target hue value memory may allow the user to designate and register a target hue value of an arbitrary color or sample point designated by a user. Arbitrary hue values designated by the user can be registered in and deleted from memory areas 1907, 1908, . . . shown in FIG. 19. When the hue values of colors designated by the user are registered in the memory areas 1907, . . . as target hue values in correspondence with sample points arbitrarily designated by the user, a mapping point of the sample point designated by the user can be mapped to have a hue value of his or her choice.

In step S1605, iso-hue curve information, used to obtain coordinate points which realize the target hue value from saturation 0 to outer edge saturation of the output gamut so as to cover the output gamut, is set. Furthermore, iso-hue curve information which realizes the target hue value at mapping lightness level Lₙ on the HVC color space and changes in the saturation direction is acquired from the image design guideline data as HVC color space coordinate values. At this time, the iso-hue curve information can be information of either successive coordinate points (line segment) or some discrete coordinate points. In this embodiment, the iso-hue curve information is provided in the latter format. The HVC color space coordinate values as the obtained iso-hue curve information are converted into Lab data, which are stored in the memory 412.

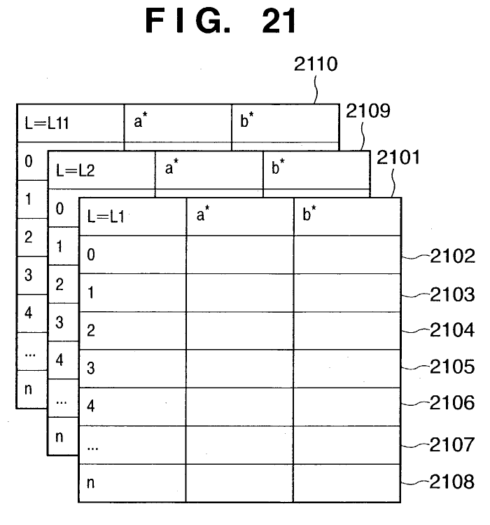

FIG. 21 shows an example of an iso-hue curve information storage area in the memory 412 that stores the set iso-hue curve information. Areas 2101, 2109, and 2111 store sets of Lab data which represent iso-hue curves at lightness levels Lₙ=L₁, L₂, . . . , L₁₁ for which iso-hue curves are to be set.

Index numbers in cells at the left end of records of fields 2101 to 2108 are assigned to an iso-hue curve in ascending order of saturation levels upon calculating the iso-hue curve, and a and b coordinate values on the iso-hue curve are stored in correspondence with the index numbers.

In step S1606, the coordinates of an intersection between the outer edge of the color gamut and the iso-hue curve are calculated on the basis of the output gamut information and the iso-hue curve information at mapping saturation level Lₙ obtained in step S1605, so as to obtain a coordinate point which realizes the target hue at the outer edge of the output gamut at mapping lightness level Lₙ and the calculated coordinates are stored in the memory 412.

In step S1607, the value of lightness level counter n is decremented. In step S1608, the value of lightness level counter n is checked. If the count value is zero, since the coordinate points and iso-hue curve information that realize all target hue values at the outer edge of the output gamut at all mapping lightness levels (L₁ to L₁₁ in this embodiment) have been calculated, all the calculated coordinate points and iso-hue curve information are stored in the mapping parameter storage memory 413 in steps S1609 and S1610, thus ending the process based on this flow.

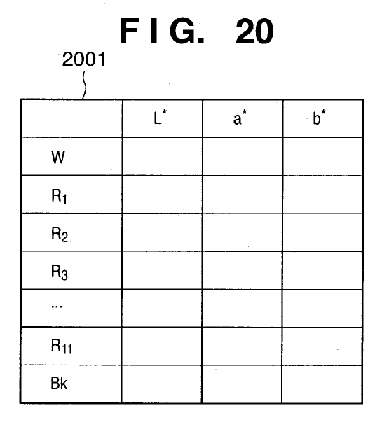

FIG. 20 shows an example of the intersection coordinate storage area in the mapping parameter storage memory 413, which stores all the calculated intersection coordinates. The memory 413 stores intersection coordinates between the outer edge of the output gamut and iso-hue curves for respective mapping lightness levels in correspondence with designated colors. FIG. 20 illustrates a state wherein intersection coordinates on the Lab color space, which correspond to surface sample points R₁ to R₁₁ and W and Bk points shown in FIG. 12, are stored.

If it is determined in step S1608 that the count value of lightness level counter n is not zero, the flow returns to step S1603 to calculate iso-hue curve information for remaining mapping lightness levels Lₙ and intersection coordinates with an iso-hue curve at the outer edge of the output gamut.

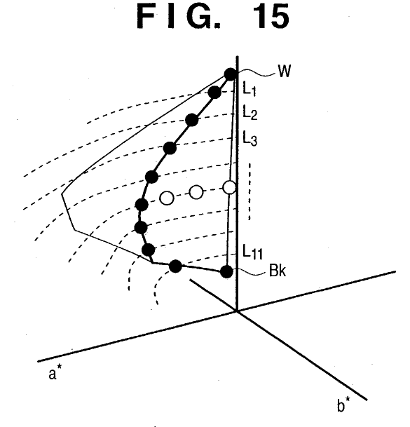

FIG. 15 shows the calculation results of iso-hue curve information. The ordinate plots lightness L*, plane coordinate axes respectively plot chromaticity values a* and b*, and the solid curve represents the output gamut. Each broken curve represents iso-hue curve information which reproduces Munsell hue 5R on the R plane in correspondence with each mapping lightness level Lₙ (L₁ to L₁₁ in this embodiment) between W and Bk.

Black dots (●) indicate intersections between the W-Red-Bk outer edge of the output gamut and iso-hue curves indicated by the broken curves, so as to express the section of a region bounded by the W-Red-Bk outer edge and a W-Bk gray line. A black dot sequence on the W-Red-Bk curve indicates actual intersection coordinates, i.e., chromaticity points which are obtained on the basis of the HVC space, which makes uniform lightness, hue, and saturation changes with respect to the human eye.

In contrast to the chromaticity points indicated by the black dots, chromaticity points on an iso-hue curve indicated by white dots (◯) appear as if saturation changes to have the same color appearance, in terms of human visual perception. Hence, upon correcting the output gamut along an iso-hue curve in adjustment of the output gamut in the process shown in FIG. 11, the color appearance of each mapping point can be preserved.

By executing the gamut mapping process shown in FIG. 3 using a new output gamut determined by the aforementioned processes, the influence of the distortion and difference of the shape of the output gamut on an output image upon gamut mapping can be reduced. Also, since corresponding points (mapping points) on the output gamut correspond to an input color signal to have the same color appearances by human visual perception, even when output gamuts have different shapes, gamut mapping to chromaticity points that appear to be the same colors by human visual perception can be implemented. In addition, since the shape of the output gamut is approximate to that of the input gamut, color impressions (color appearances) among images output using different output media (having different output gamut shapes) can be adjusted.

Second Embodiment

An image processing apparatus according to the second embodiment of the present invention will be described hereinafter. Note that the same reference numerals in the second embodiment denote the same parts as in the first embodiment, and a detailed description thereof will be omitted.

[Arrangement]

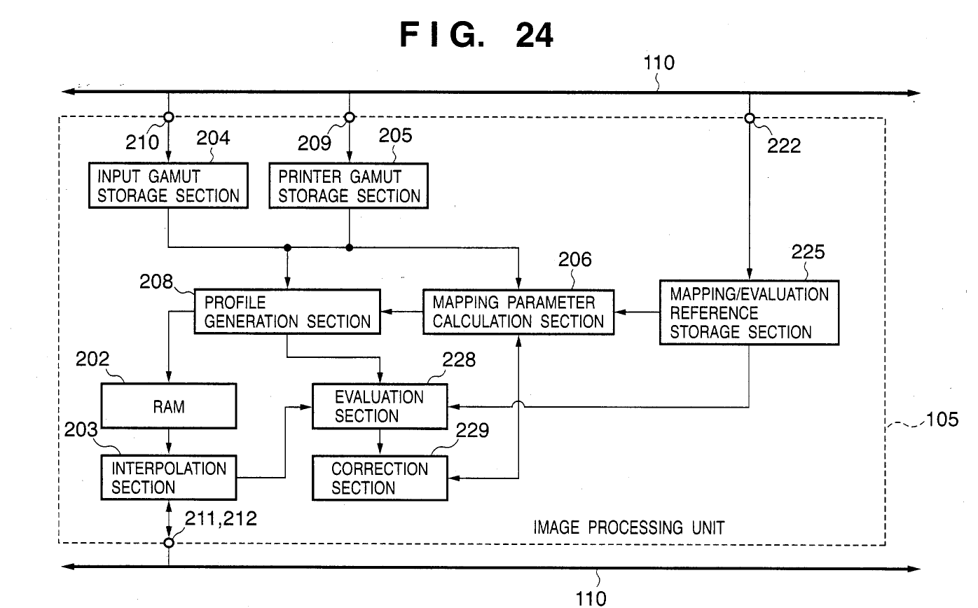

FIG. 24 is a block diagram showing the detailed arrangement of the image processing unit 105. The image processing unit 105 is characterized by generating a profile used upon mapping the input gamut of an arbitrary input color space onto an output gamut on the basis of mapping reference data, and executing evaluation and correction processes of the profile.

A mapping/evaluation reference storage section 225 stores parameters and algorithms used to execute a process that makes the color conversion results of an input color signal have similar color appearances even when output gamuts have different shapes, and parameters and algorithms required for a color correction process that realizes desired image quality (these parameters and algorithms will be collectively referred to as “mapping/evaluation reference data” hereinafter), as some of its functions. The mapping/evaluation reference storage section 225 can load and store mapping/evaluation reference data that realizes desired image quality when it is connected to another arrangement via a terminal 222 and the system bus 110. Note that the mapping/evaluation reference storage section 225 may store a plurality of mapping/evaluation reference data, and these data may be switched in accordance with a user's instruction, so as to implement a color correction process of user's choice.

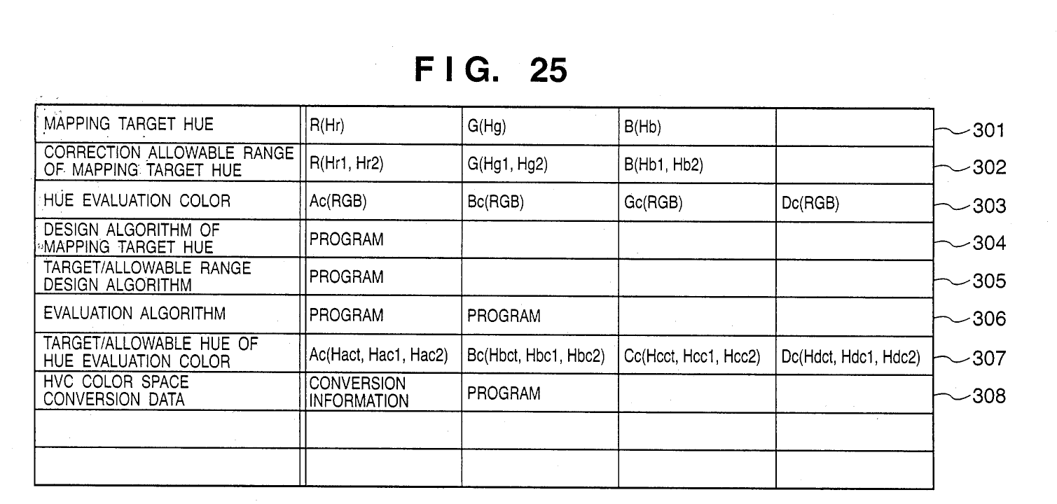

FIG. 25 shows an example of the memory configuration of the mapping/evaluation reference storage section 225, i.e., mapping/evaluation reference data stored in the section 225.

A memory field 301 shown in FIG. 25 stores mapping target hues of respective color components red (R), green (G), and blue (B) on the input color space upon mapping predetermined sample points on curves W-R-Bk, W-G-Bk, and W-B-Bk, which connect white (W) and black (Bk) via R, G, and B, onto the output gamut, in the form of hue values on the HVC color space.

A memory field 302 stores information of hue correction allowable ranges at R, G, and B mapping points, which are referred to when a correction section 209 shown in FIG. 24 corrects a profile. A memory field 303 stores the RGB values of four colors Ac to Dc on the input color space. A memory field 304 stores a program of mapping target hue design algorithm (to be described later).

A memory field 305 stores a program of target/allowable range design algorithm, and a memory field 306 stores programs of evaluation algorithms, which are loaded by an evaluation section 228 shown in FIG. 24 to implement an evaluation process.

A memory field 307 is set with respective target hue values and allowable ranges by color reproduction for hue evaluation items Ac to Dc to be referred to by the evaluation section 228, using hue values on the HVC color space. A memory field 308 stores a program of an algorithm that implements coordinate conversion between the HVC and Lab spaces.

The profile generation section 208 can implement a color conversion process which can make the color conversion results of an input color signal appear the same, even when output gamuts have different shapes, by executing a mapping process on the basis of the mapping/evaluation reference data that stores parameter generation data, mapping programs, and the like, as shown in FIG. 25. More specifically, a color conversion profile is generated or corrected with reference to mapping points and mapping control parameters, which are generated by the mapping parameter calculation section 206 on the basis of the mapping/evaluation reference data.

The setting process of mapping points and mapping control parameters used to generate a profile in the second embodiment will be described in detail below.

[Setting Process of Mapping Points]

The mapping parameter generation section 206 loads the mapping target hues and mapping target hue design program from the memory fields 301 and 304 of the mapping/evaluation reference storage section 205, and sets mapping points, which express similar color appearances even on different output gamuts, in correspondence with R, G, and B color components.

The process for setting mapping points which express similar color appearances even on different output gamuts in the mapping parameter calculation section 206 will be described below taking a red (R) component as an example.

In the second embodiment, colors which express similar color appearances even on output gamuts having different shapes shown in FIG. 10 are acquired as mapping points on the basis of iso-hue curve information on the HVC color space. As described above, hue H of a mapping point on the output gamut is a hue value on the HVC space, and must undergo coordinate conversion (mapping process) to an Lab space as a representation coordinate system of the output gamut. A program that implements coordinate conversion between the HVC and Lab space is stored in the memory field 308 of a mapping/evaluation reference storage section 225 together with conversion information. Hence, even when a special value such as a coordinate value on the HVC space or the like is designated in place of a value on the Lab space used in a normal mapping process upon setting mapping control parameters on the basis of mapping/evaluation reference data, the mapping parameter calculation section 206 reads out the aforementioned color space conversion program and conversion information from the mapping/evaluation reference data to execute color space conversion.

The profile generation section 208 sets a profile that converts surface sample points R₁ to R₁, shown in FIG. 12 into points R₁′ to R₁₁′ with mapping lightness levels shown in FIG. 14 corresponding to the output gamut shown in FIG. 13A.

[Setting Process of Mapping Control Parameters]

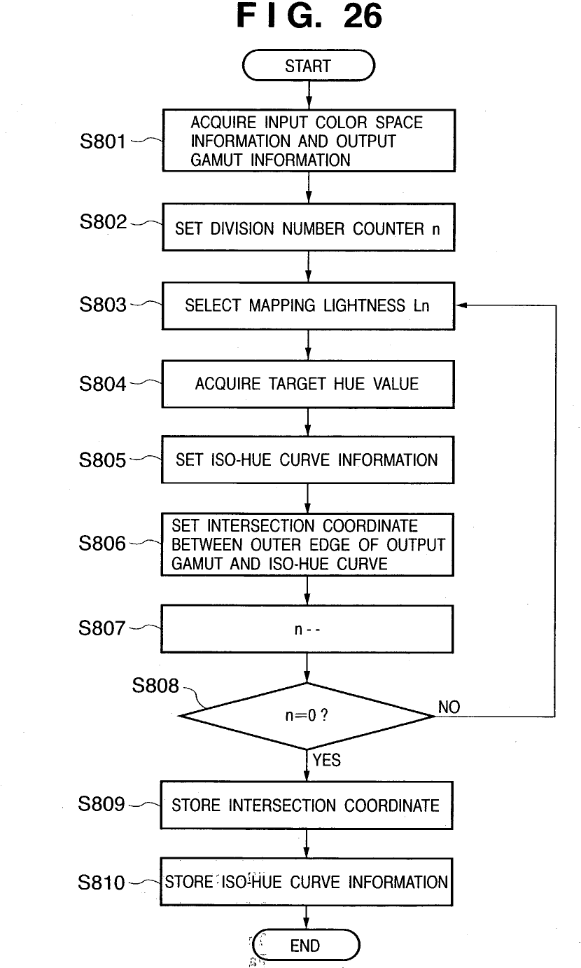

The mapping parameter calculation section 206 sets intersection coordinates between the iso-hue curve and the outer edge of the output gamut, as mapping control parameters. The process for setting the mapping control parameters will be described in detail below with reference to the flow chart shown in FIG. 26.

More specifically, a mapping objective hue range (iso-hue curve information) on the output gamut with respect to sample points is set on the basis of mapping lightness levels (FIG. 14) set at the surface sample points R₁′ to R₁₁′, or the hue value on the HVC color space, which is defined in advance in the mapping/evaluation reference data for a hue corresponding to surface sample points. In the description of FIG. 26, L₁ to L₁₁ represent the mapping lightness levels of the surface sample points R₁′ to R₁₁′.

In step S801, input color space information and output gamut information are input. In step S802, a counter (division number counter n) which indicates the lightness number for which iso-hue curve information is to be set is set. In step S803, mapping lightness level Lₙ is selected.

In step S804, a target hue value of each color designated with a sample point is acquired in correspondence with mapping lightness level Lₙ. Note that target hue values are pre-stored in the memory field 301 of the mapping/evaluation reference storage section 255 for respective colors, and are expressed by hue values on the Munsell notation color space. Hence, in step S804 Munsell hue value Hr as the designated hue value of red (R) is read out from the memory field 301, and is acquired as a target hue value.

Assume that mapping points of surface sample points Ri which shift on a W-R₆-Bk curve on the surface of the input gamut shown in FIG. 12 have the same hue (mapping hue), for the sake of simplicity. If points Ri have different mapping hues, a hue that achieves optimal color reproduction at a mapping lightness level may be held in the mapping/evaluation reference data as a mapping target hue in correspondence with index i, and may be acquired as a target hue value.

In this manner, since the Munsell notation color space is defined as the HVC space used to obtain iso-hue curve information for each lightness level, and information that specifies correspondence between the Munsell notation color space and Lab color space is stored as the mapping/evaluation reference data, iso-hue curve information for each mapping lightness level can be set on the basis of target hue value Hr and mapping lightness level Lₙ. Hence, in step S805 iso-hue curve information, used to obtain coordinate points which realize the target hue value from saturation 0 to outer edge saturation of the output gamut so as to cover the output gamut, is set.

More specifically, iso-hue curve information which realizes target hue value Hr at mapping lightness level Lₙ on the HVC color space and changes in the saturation direction is acquired as HVC color space coordinate values on the basis of HVC color space reference data (to be described later) which defines an Lab-HVC conversion program and the like. Note that the iso-hue curve information can be information of either successive coordinate points (line segment) or some discrete coordinate points. In the second embodiment, the iso-hue curve information is provided in the latter format. The obtained iso-hue curve information (HVC color space coordinate values) is converted into Lab data and is stored in the memory 412 in the mapping parameter calculation section 206 in step S810 to be described later, as shown in FIG. 21.

In step S806, an intersection coordinate point between the outer edge of the output gamut and iso-hue curve is calculated on the basis of the output gamut information and the iso-hue curve information obtained in step S805 so as to obtain a coordinate point which realizes target hue Hr at the outer edge of the output gamut at mapping lightness level Lₙ.

In step S807, the count value of division number counter n is decremented. In step S808, the count is checked. If the count value is zero, this means that the coordinate points and iso-hue curve information that realize target hue values at the outer edge of the output gamut at all mapping lightness levels for which iso-hue curve information is to be set have been calculated. Therefore, in this case, the flow advances to step S809, and all the calculated coordinate points are stored in the mapping parameter storage memory 413, as shown in FIG. 21. Furthermore, iso-hue curve information is similarly stored in step S810, thus ending the mapping control parameter setting process.

If it is determined in step S808 that the value of division number counter n is not zero, the flow returns to step S803 to calculate iso-hue curve information for remaining mapping lightness levels Lₙ and intersection coordinates with an iso-hue curve at the outer edge of the output gamut.

The calculation results of the iso-hue curve information are as shown in FIG. 15.

The profile generation section 208 sets a profile that maps the surface sample points R₁ to R₁₁ shown in FIG. 12 to R₁′ to R₁₁′ shown in FIG. 14 on the basis of the intersection coordinates and iso-hue curve information stored in the mapping parameter storage memory 413.

[Evaluation of Color Reproducibility]

An evaluation process of color reproducibility that evaluates if the profile set as described above can obtain sufficiently high color reproducibility will be described in detail below.

An interpolation section 203 executes a color conversion process on the basis of the profile, which is generated by the profile generation section 208 and is stored in the RAM 202. This color conversion result is evaluated by the evaluation section 228. The evaluation section 228 acquires color reproduction values of hue evaluation colors used to evaluate the set image quality from the mapping/evaluation reference storage section 225 with reference to the profile, and evaluates their chromaticity points. As the hue evaluation colors, the RGB values of four colors Ac to Dc of those on the input color space are set, as shown in the memory field 303 in FIG. 25.

The evaluation section 228 acquires the color conversion results of the RGB values of hue evaluation colors Ac to Dc by the interpolation section 203 as coordinate values on the Lab color space with reference to the output gamut information, and evaluates these coordinate values. In the memory field 307 in FIG. 25, target hue values (Ht) and allowable ranges (H1, H2) of hue evaluation colors Ac to Dc are set as hue values on the HVC color space.

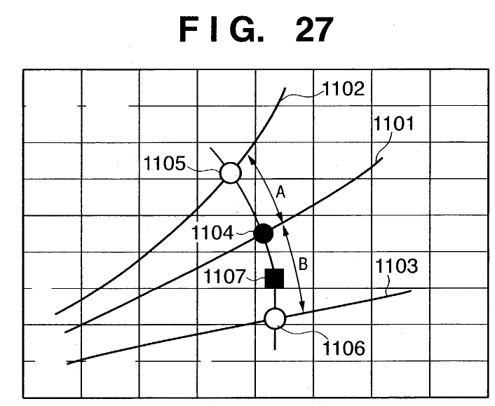

FIG. 27 shows the relationship between the target hue value and allowable range of each hue evaluation color. FIG. 27 shows the a*b* coordinate plane at lightness of an evaluation objective color. A curve 1101 represents an iso-hue curve of the target color value of the evaluation objective color, and curves 1102 and 1103 represent those of the allowable ranges.

In FIG. 27, assuming that a black square (▪) indicates a point (hue evaluation color) of the evaluation objective, a target color having the same lightness and saturation as those of the evaluation objective color 1107 is located at a point indicated by a black dot (●) 1104, and limit points of the allowable range having the same lightness and saturation as those of the evaluation objective color are indicated by white dots (◯) 1105 and 1106. Also, a region sandwiched between the point (●) 1104 of the target color and the limit point (◯) 1105 of the allowable range is defined as allowable range A, and a region sandwiched between the point (●) 1104 of the target color and the limit point (◯) 1106 of the allowable range is defined as allowable range B.

The evaluation section 228 loads and executes a target/allowable range design program stored in the memory field 305 in FIG. 25, and an evaluation program stored in the memory field 306, thus implementing an evaluation process.

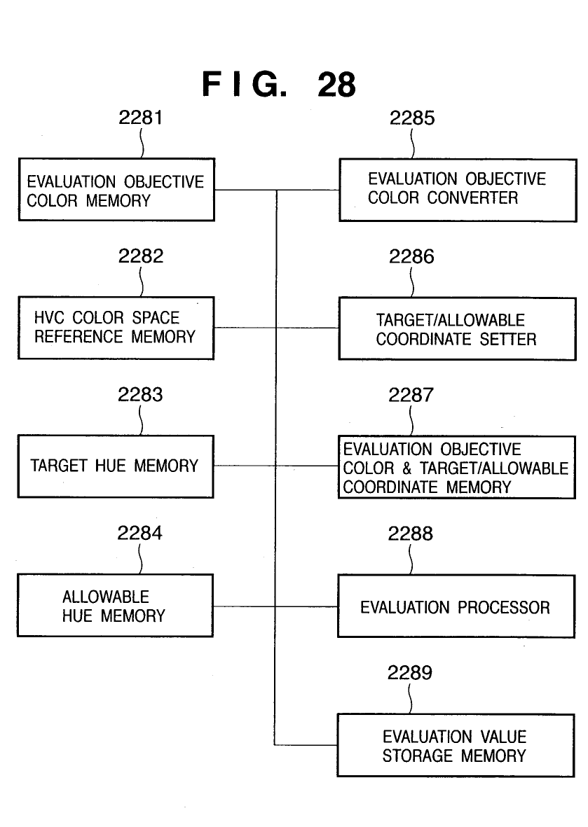

FIG. 28 is a block diagram showing the detailed arrangement of the evaluation section 228.

In FIG. 28, an evaluation objective color memory 2281 stores the attributes of evaluation objective colors and their coordinate values on the Lab color space, which are acquired in correspondence with hue evaluation colors Ac to Dc on the basis of the profile generated by the profile generation section 208.

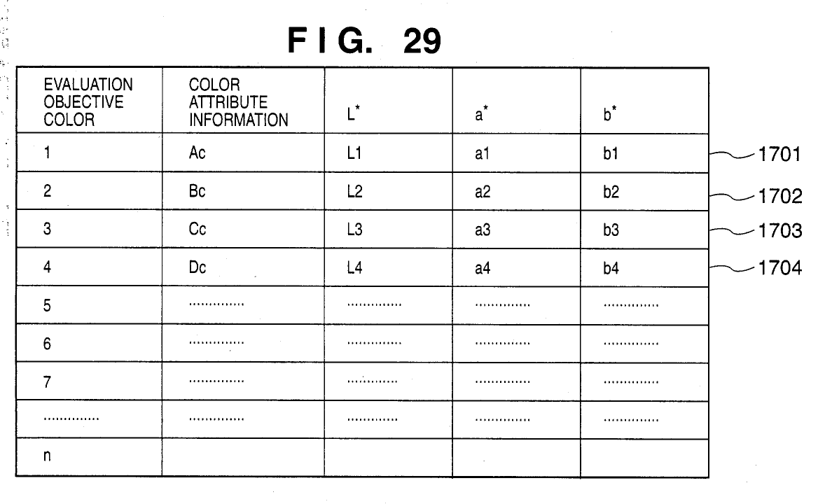

FIG. 29 shows an example of data stored in the evaluation objective color memory 2281. The evaluation objective color memory 2281 stores color attribute information of objective colors and their coordinate values on the Lab color space for respective indices so as to store a plurality of evaluation objective colors. In FIG. 29, a memory field 1701 stores an Ac identifier used to evaluate the evaluation objective color as hue evaluation color Ac, and the coordinate value of the evaluation objective color on the Lab color space, as color attribute information of index 1. Likewise, memory fields 1702 to 1704 store data associated with hue evaluation colors Bc to Dc.

Referring back to FIG. 28, an evaluation objective color data converter 2285 sets lightness information and saturation information on the HVC color space on the basis of the coordinate value of the evaluation objective color on the Lab color space, which is stored in the evaluation objective color memory 2281. The set lightness information and saturation information are stored in an evaluation objective color & target/allowable coordinate memory 2287 together with the coordinate value of the evaluation objective color on the Lab color space.

An HVC color space reference memory 2282 stores HVC-Lab conversion information and its conversion program loaded from the memory field 308 of the mapping/evaluation reference storage section 225, and the stored information and program are used upon HVC-Lab conversion in another processor as needed.

A target hue memory 2283 and allowable hue memory 2284 respectively store the target hue value and allowable hue value for the color attribute information of the evaluation color as hue values on the HVC color space, which are loaded from the memory field 307 of the mapping/evaluation reference storage section 225. Note that the Lab values of hues which have the same lightness and saturation and are based on their target hue values and allowable ranges are calculated based on the HVC-Lab conversion information in correspondence with those of hue evaluation colors Ac to Dc, and the calculated Lab values as target chromaticity points and allowable chromaticity points are stored in the evaluation objective color & target/allowable coordinate memory 2287.

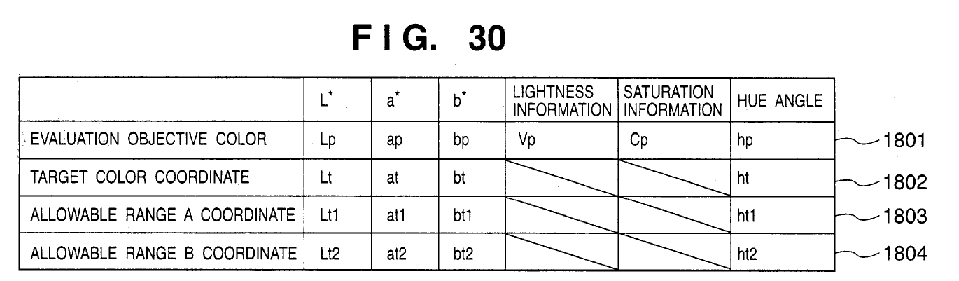

FIG. 30 shows an example of data stored in the evaluation objective color & target/allowable coordinate memory 2287. A memory field 1801 shown in FIG. 30 stores an Lab value (Lp, ap, bp) of the evaluation objective color, calculated lightness information Vp and saturation information Cp on the HVC color space, and hue angle hp calculated from the Lab value. Note that hue angle h on the Lab color space is calculated based on an Lab value (L, a, b) by:

h=tan⁻¹ (a/b) (1)

A memory field 1802 stores an Lab value (Lt, at, bt) of the target color of the evaluation objective color, and hue angle ht calculated from that Lab value. A memory field 1803 stores an Lab value (Lt1, at1, bt1) of the evaluation objective color in one allowable range A, and hue angle ht1 calculated from that Lab value. A memory field 1804 stores an Lab value (Lt2, at2, bt2) of the evaluation objective color in the other allowable range B, and hue angle ht2 calculated from that Lab value.

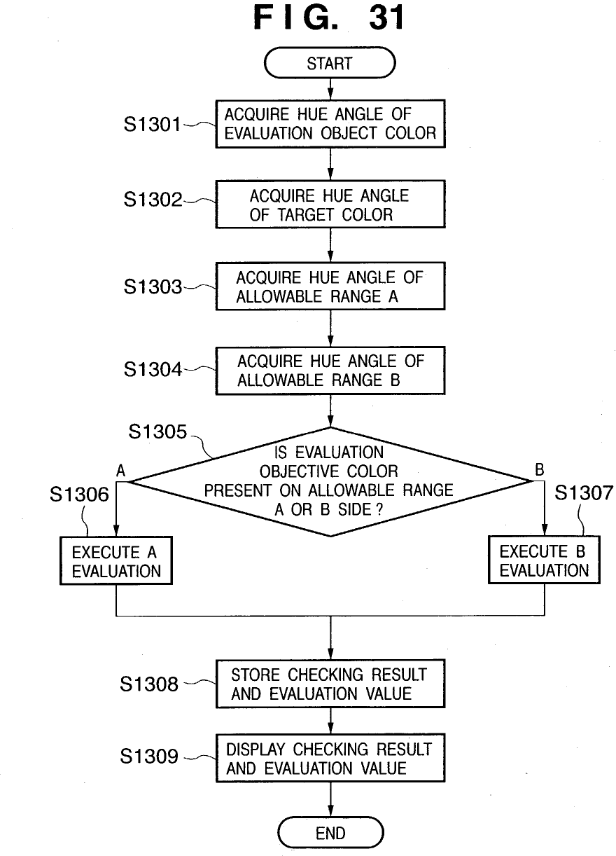

The color reproducibility evaluation process in an evaluation processor 2288 shown in FIG. 28 will be described in detail below. FIG. 31 is a flow chart showing the color reproducibility evaluation process in the evaluation processor 2288, i.e., an allowable range inside/outside checking process of the color conversion result of the evaluation objective color.

In step S1301, hue angle hp of the evaluation objective color is acquired from the evaluation objective color & target/allowable coordinate memory 2287. In steps S1302 to S1304, hue angle ht, hue angle ht1 in allowable range A, and hue angle ht2 in allowable range B of the target color are respectively acquired from the evaluation objective color & target/allowable coordinate memory 2287.

It is checked in step S1305 by comparing hue angle ht of the evaluation objective color with hue angle ht1 in allowable range A or hue angle ht2 in allowable range B if the evaluation objective color is present on allowable range A or B side.

If it is determined that the evaluation objective color is present within allowable range A, the evaluation objective color is evaluated (A evaluation) on the basis of the target color and allowable range A in step S1306. On the other hand, if it is determined that the evaluation objective color is present within allowable range B, the evaluation objective color is evaluated (B evaluation) on the basis of the target color and allowable range B in step S1307. Note that details of the evaluation processes in steps S1306 and S1307 will be described later.

Upon completion of the evaluation process, the allowable range inside/outside checking result and the evaluation value of the evaluation objective color are stored in an evaluation value storage memory 2289 in step S1308. In step S1309, the allowable range inside/outside checking result of each evaluation color and the evaluation value of the evaluation objective color, which are stored in the evaluation value storage memory 2289, are displayed on the monitor 106 to inform the user of them.

According to the color reproducibility evaluation process shown in FIG. 31, the allowable range inside/outside checking result can be obtained on the basis of allowable range information in the mapping/evaluation reference data.

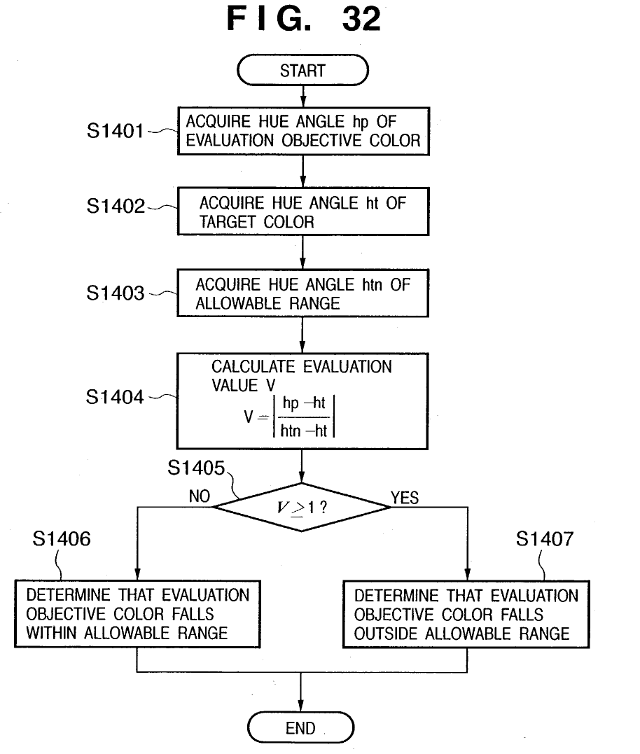

FIG. 32 is a flow chart showing the process for checking if the evaluation objective color falls within or outside the allowable range and for obtaining the evaluation value in steps S1306 and S1307.

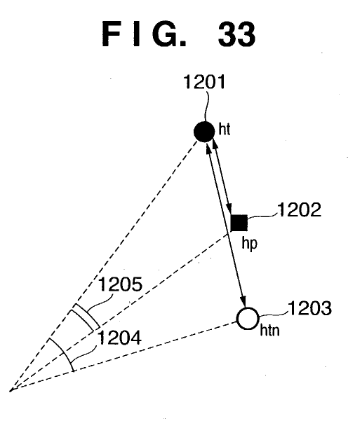

FIG. 33 shows the relationship among the allowable range, evaluation objective color, and target color, which are used to evaluate the evaluation objective color. In FIG. 33, a black dot (●) 1201 indicates the target color, which has hue angle ht. Also, a white dot (◯) 1203 indicates the allowable range, which has hue angle htn. A black square (▪) 1202 indicates the evaluation objective color, which has hue angle hp. Reference numeral 1204 denotes the difference between the hue angles of the target color 1201 and allowable range 1203; and 1205, the difference between the hue angles of the target color 1201 and evaluation objective color 1202.

In steps S1401 to S1403 in FIG. 32, hue angle hp of the evaluation objective color, hue angle ht of the target color, and hue angle htn of the allowable range are respectively acquired. In step S1404, evaluation value V of the evaluation objective color is defined and calculated by:

V=|(hp−ht)|/|(htn−ht)| (2)

Evaluation value V represents the ratio of the difference 1205 between the hue angles of the target color 1201 and evaluation objective color 1202 to the difference 1204 between the hue angles of the target color 1201 and allowable range 1203 in FIG. 33. This ratio indicates the degree of resemblance of the evaluation objective color to the color appearance of the target color, i.e., how close the evaluation objective color appears to be the target color. As evaluation value V is closer to zero, the evaluation objective color appears to be the target color; if it is closer to 1, the degree of resemblance of the evaluation objective color to the target color is reduced. Furthermore, if evaluation value V exceeds 1, it is evaluated that the evaluation objective color does not resemble the target color. Therefore, it is checked in step S1405 if evaluation value V calculated in step S1404 exceeds 1. If V<1, it is determined in step S1406 that the evaluation objective color falls within the allowable range; if V>1, it is determined in step S1407 that the evaluation objective color falls outside the allowable range.

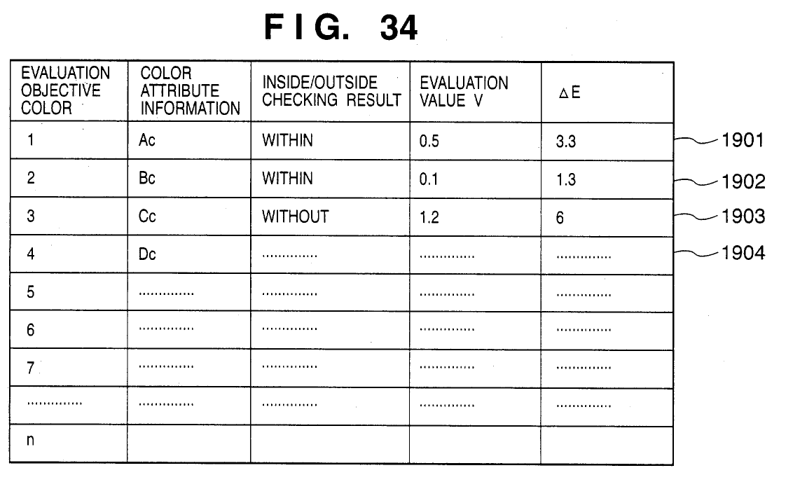

As described above, the evaluation result of the evaluation processor 2288 is stored in the evaluation value storage memory 2289. FIG. 34 shows an example of data stored in the evaluation value storage memory 2289. Referring to FIG. 34, a memory field 1901 stores the color reproducibility evaluation result of evaluation objective color Ac indicated by index 1. Likewise, memory fields 1902, 1903, 1904, . . . store the color reproducibility evaluation results of the evaluation objective colors indicated by indices 2, 3, 4, . . . . In this manner, the evaluation value storage memory 2289 stores the evaluation results of the evaluation objective colors in correspondence with indices and color attribute information. As the evaluation result, the inside/outside checking result, evaluation value V, and distance ΔE between the Lab values of the target color and evaluation objective color are stored.

Profile Generation/correction Process

A correction section 229 determines based on the total evaluation result of the evaluation section 228 if the generated profile is to be corrected. The total evaluation value is obtained by, e.g., integrating the evaluation values calculated for respective evaluation objective colors by the evaluation section 228. If this total evaluation value is equal to or higher than a predetermined threshold value, it is determined that the profile is inappropriate. Note that the threshold value used in this determination process can be appropriately set in the system.

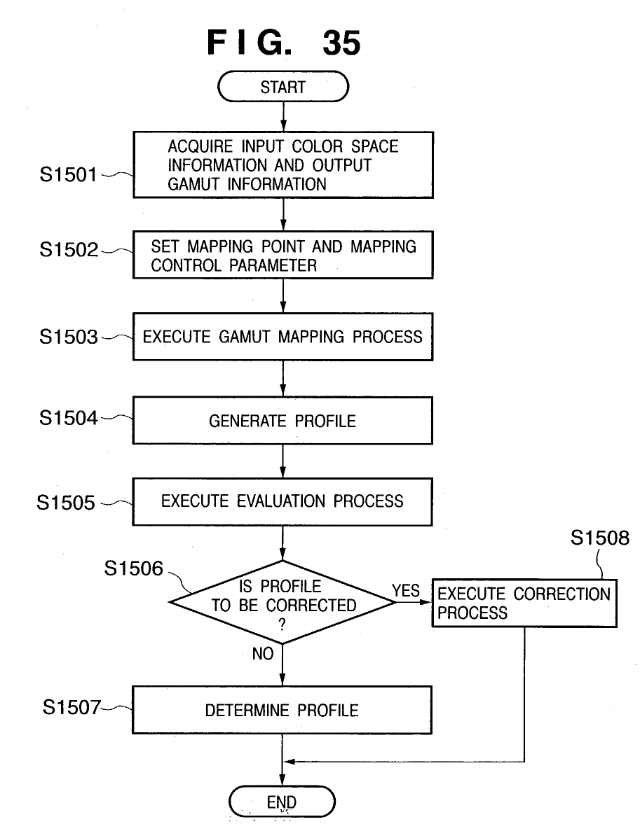

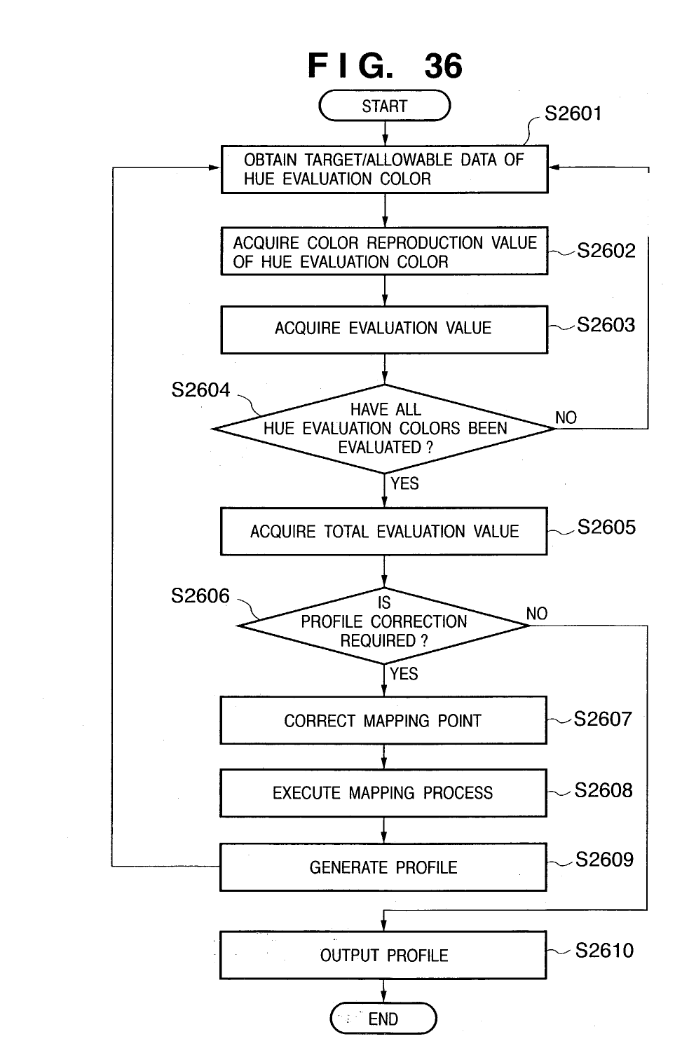

The profile generation and correction processes will be described in detail below with reference to the flow charts shown in FIGS. 35 and 36.

The mapping parameter calculation section 206 acquires input gamut information and output gamut information in step S1501, and generates mapping points and mapping control parameters on the basis of mapping determination parameters and a program stored in the mapping/evaluation reference storage section 225 in step S1502. The gamut mapping section 207 executes gamut mapping on the basis of the mapping points and mapping control parameters in step S1503. The profile generation section 208 generates a profile on the basis of the mapping result in step S1504. The evaluation section 228 executes the aforementioned inside/outside checking process for evaluation objective colors set based on mapping/evaluation reference data, and calculates evaluation values in step S1505.

The correction section 229 checks in step S1506 based on the total evaluation value if the profile is to be corrected. Note that this checking process may be executed in accordance with the presence/absence of a user's profile correction instruction. If it is determined that the profile is not to be corrected, the profile generated in step S1504 is determined as a color conversion profile, and the process ends. On the other hand, if it is determined that the profile is to be corrected, the flow advances to step S1508 to execute a profile correction process in the correction unit 229.

FIG. 36 is a flow chart showing the profile correction process in the correction unit 229 in step S1508. Note that steps S2601 to S2603 in FIG. 36 are processes in the evaluation section 228, and the mapping process and profile generation process in steps S2608 and S2609 are processes in the gamut mapping section 207 and profile generation section 208. If it is determined in the process shown in FIG. 35 that the profile is to be corrected, the process starts from step S2607. However, in the following description, the process will start from acquisition of a hue evaluation color.

The evaluation section 228 obtains target/allowable hue data of a hue evaluation color from the memory field 307 of the mapping/evaluation reference storage section 225 in step S2601. The color reproduction value of the hue evaluation color is acquired in step S2602, and the evaluation value of the hue evaluation color is acquired in step S2603.

The correction section 229 checks in step S2604 if evaluation values of all the hue evaluation colors have been acquired. If evaluation values to be acquired still remain, the flow returns to step S2601 to repeat the evaluation process. On the other hand, if the evaluation values of all the hue evaluation colors have been acquired, the flow advances to step S2605 to acquire the total evaluation value.

It is checked in step S2606 on the basis of the total evaluation value acquired in step S2605 if the profile need be corrected. If the profile need be corrected, the correction section 229 corrects mapping points used to generate a profile in step S2607. That is, the correction section 229 refers to the hue correction allowable range of the mapping points, which is set in the memory field 302 of the mapping/evaluation reference storage section 225 via the mapping parameter calculation section 206, and corrects the mapping points within this allowable range. A mapping process is executed using the corrected mapping points in step S2608, and a profile is generated based on the mapping result in step S2609.

After that, the flow returns to step S2601 to repeat the above processes, thus obtaining the evaluation value for the corrected profile generated in step S2609.

If it is determined in step S2606 that the profile wins the best total evaluation value or is allowable (the total evaluation value is equal to or lower than the threshold value), the flow jumps to step S2610 to output the generated profile as a color conversion profile, thus ending the process.

As described above, according to the second embodiment, the color reproducibility evaluation process based on the allowable ranges and hue evaluation colors of the pre-stored mapping/evaluation reference data, and the profile correction process based on the evaluation result can provide a profile that makes color conversion suitable for the output gamut.

In the second embodiment, the correction section 229 may set various combinations of mapping points within the correction allowable range to generate profiles, the evaluation section 228 calculates the evaluation values of these profiles, and a profile with the best total evaluation value may be determined as a color conversion profile. In this way, a profile that makes color conversion optimal to the output gamut can be provided.

The evaluation colors used in the evaluation process are not limited to hue values, but lightness and saturation values may be used.

Upon setting various combinations of mapping points within the correction allowable range by the correction section 229, the user may set the intervals of hue values and the like used to segment the correction allowable range via the console 104. As a result, the profile correction result can be verified at the color correction precision of user's choice.

Third Embodiment

An image processing apparatus according to the third embodiment of the present invention will be described below.

Note that the same reference numerals in the third embodiment denote the same parts as in the first embodiment, and a detailed description thereof will be omitted.

[Generation of Profile]

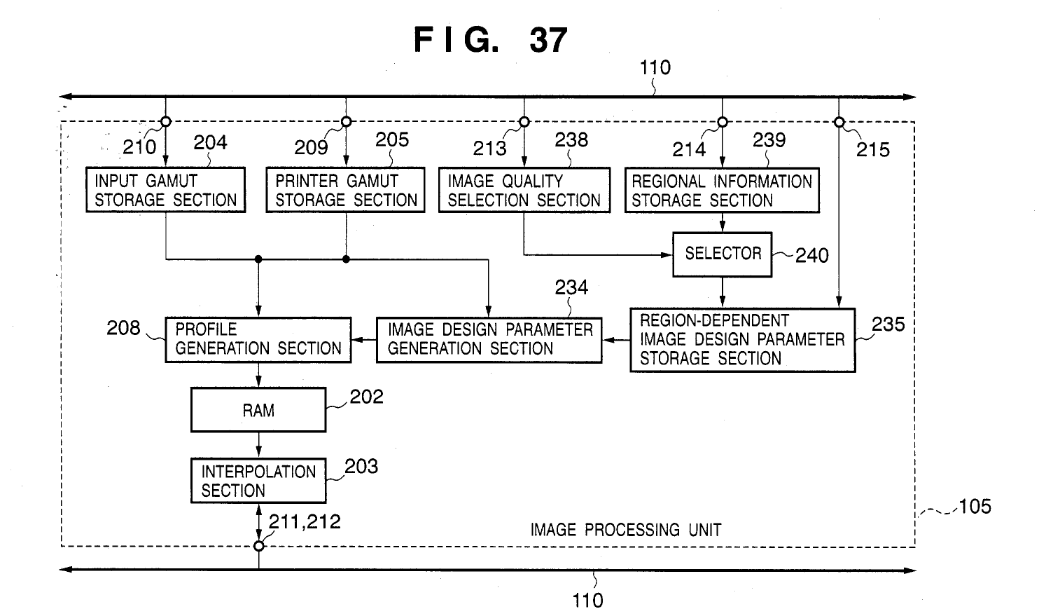

FIG. 37 is a block diagram for explaining a profile generation process using image design parameters in the image processing unit 105. Note that a profile generated by the image processing unit 105 is used to map the input gamut of an arbitrary input color space into an arbitrary output gamut.

The image design parameters are information associated with hues to be reproduced in respective regions of red, green, and blue (to be referred to as “secondary colors” hereinafter) reproduced by a printer as the output device 108. Also, an algorithm for obtaining chromaticity points of secondary colors having hues to be reproduced based on regional information on an output gamut is available. With these image design parameters and algorithm, reproduction colors of the secondary colors having hues optimized to a given region on an arbitrary output gamut can be determined.

Furthermore, using parameters that define contrast (gamma characteristics) between chromaticity points of RGB white or black to that optimized to a given region, and an algorithm that determines tone characteristics, optimal tone characteristics can be determined on an arbitrary output gamut.

In addition to the image design parameters of the secondary colors, design parameters of hue, saturation, and lightness values required to generate a profile in association with the reproduction colors of chromaticity points in an input gamut or reproduction of lightness, saturation, and hue change characteristics and the like between two chromaticity points, an algorithm for obtaining an optimal reproduction color on an arbitrary output gamut on the basis of the above design parameters, and parameters and an algorithm associated with a color mapping process will be generally referred to as image design parameters.

On the other hand, the image design parameters can be those for optimizing an output signal value of the input device 107 in accordance with regional characteristics based on the gamut of not only the output device 108 but also the input device 107, and parameters for determining color reproducibility of a final output image signal on the basis of the output gamut of the output device 108 and the gamut of the input device 107, and an algorithm may be used.

With the aforementioned image design parameters, a profile which outputs an optimal image based on regional information for a combination of input and output gamuts of arbitrary shapes can be automatically designed.

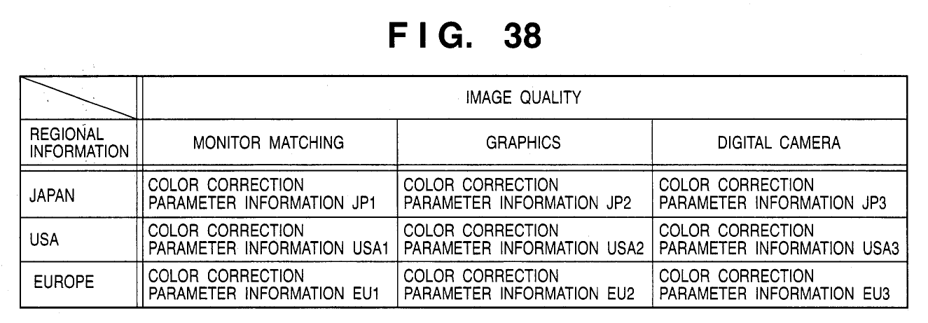

A region-dependent image design parameter storage section 235 stores, as some of its functions, image design parameters corresponding to regional information. The image design parameters have those corresponding to a plurality of image qualities and a plurality of pieces of regional information so as to realize image quality according to the regional characteristics. FIG. 38 shows an example of an image design parameter table.

In the example shown in FIG. 38, “Japan”, “USA”, and “Europe” are available as regional information, and three different image qualities, i.e., “monitor matching” that allows color reproduction faithful to a monitor, “graphics” that outputs figures and text images with healthy colors, and “digital camera” that attains optimal color correction of a digital camera image, are available. That is, FIG. 38 shows an example of a table which has three different types of image design parameters corresponding to three regions. Of course, various other regional information and image qualities can be set.

The region-dependent image design parameter storage section 235 is connected to a host computer via a terminal 215 (or to a network via a network interface card), and can load and store image parameters which can realize regional information and/or image quality of user's choice. Of course, regional information and image design parameters can be arbitrarily registered and deleted.

An image quality selection section 238 receives information indicating image quality required to generate a profile of user's choice, via a terminal 213. Also, a regional information storage section 239 receives and stores regional information of a profile to be generated. Note that regional information is acquired by the following methods:

(1) Refer to regional information set in the host computer.

(2) Refer to regional information set in the output device 108.

(3) Refer to regional information set in the input device 107.

(4) Prompt the user to input.

(5) Acquired from a device such as GPS which can acquire position information.

If regional information fails to be acquired by the aforementioned methods, a default value may be set. Also, automatic acquisition conditions of regional information are as follows.

(1) When regional information is stored in the input device 107.

(2) When regional information is stored in the output device 108.

(3) Refer to regional information according to priority if both the input and output devices store regional information.

(4) When the user inputs regional information.

After the information indicating the image quality and the regional information are set, the region-dependent image design parameter storage section 235 that controls a selector 240 selects image design parameters corresponding to the information indicating the image quality input to the image quality selection section 238 and the regional information stored in the regional information storage section 239, and sends them to an image design parameter generation section 234.

On the other hand, information associated with the gamut of the input device 107 (input color space information) is input via a terminal 210, information associated with the output gamuts of the monitor 106 and output device 108 (output gamut information) is input via a terminal 209, and they are respectively stored in the input gamut information storage section 204 and printer gamut information storage section 205.

The image design parameter generation section 234 calculates color space compression parameters required for a mapping process in the profile generation section 208 with reference to the output gamut information of the monitor 106 or output device 108 stored in the printer gamut information storage section 205, the input color space information stored in the input gamut information storage section 204, and the image design parameters.

The profile generation section 208 generates a profile used to map the gamut of the input device 107 to the output gamut of the monitor 106 or output device 108 with reference to the output gamut information of the monitor 106 or output device 108 stored in the printer gamut information storage section 205, the input color space information stored in the input gamut information storage section 204, and the color space compression parameters calculated by the image design parameter generation section 234, so as to reproduce image quality with required tone characteristics. In the following description, the output gamut of that mapping result will be referred to as a “mapping output gamut”. The profile generated by the profile generation section 208 contains information indicating the correspondence between the input gamut and mapping output gamut, and correspondence between color information (e.g., RGB data) output from the input device 107, and color information (e.g., RGB data or CMYK data) used to form colors by the monitor 106 or output device 108. The generated profile is written in the RAM 202.

A terminal 211 receives, e.g., RGB data from the host computer. The interpolation section 203 converts the input RGB data into RGB data for the monitor 106 or, e.g., CMYK data for the output device 108 with reference to the profile stored in the RAM 202, and outputs the converted data to the host computer via a terminal 216. Image data output from the image processing unit 105 is output to the monitor 106 or output device 108 by the host computer.

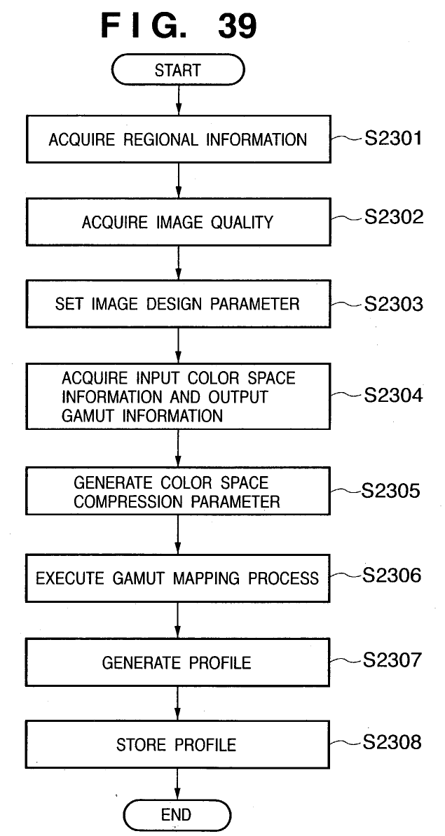

FIG. 39 is a flow chart for explaining a profile generation sequence, i.e., a process to be executed by the CPU 101 by controlling the image processing unit 105.

Regional information and information indicating image quality are acquired, and are stored in the image quality selection section 238 and regional information storage section 239 (S2301, S2302). Image design parameters corresponding to the regional information and information indicating image quality are selected from the region-dependent image design parameter storage section 235, and are set in the image design parameter generation section 234 (S2303).

Input color space information and output gamut information are then acquired, and are stored in the input gamut information storage section 204 and printer gamut information storage section 205 (S2304).

The image design parameter generation section 234 generates color space compression parameters on the basis of the input color space information, output gamut information, and image design parameters (S2305).

The profile generation section 208 executes a gamut mapping process for mapping the input gamut onto the output gamut on the basis of the color space compression parameter (S2306), and generates a profile used to convert image data on the input gamut into that on the output gamut on the basis of the mapping result (S2307). The generated profile is stored in the RAM 206 (S2308).

In this manner, since image design parameters corresponding to regionality of color favor and image observation characteristics (especially, illumination light) are selected on the basis of the acquired regional information and image quality information, and a color conversion profile is generated based on the selected image design parameters, color conversion corresponding to the regionality and observation environment of the user who observes an output image can be implemented.

In the third embodiment, image design parameters which are respectively optimized in correspondence with different output media with different output gamuts may be prepared, output medium information may be acquired by a predetermined method (e.g., designated by the user), and image design parameters may be selected based on the regional information, image quality information, and output medium information. In this way, appropriate color conversion that reflects regional information can be implemented for different output media with different output gamut shapes.

The image design parameters may have color conversion parameters and an algorithm used to make color conversion to obtain the same color appearances of output images in correspondence with different output gamut shapes of different output media, and image parameters may be selected based on the regional information and image quality information, so as to make color conversion. In this manner, color conversion that reflects regional information and can assure the same color appearances of output images can be implemented for different output media with different output gamut shapes.

As many apparently widely different embodiments of the present invention can be made without departing from the spirit and scope thereof, it is to be understood that the invention is not limited to the specific embodiments thereof except as defined in the appended claims.

What is claimed is:

1. A color processing method to convert an input signal into an output color signal, comprising the steps of:
determining mapping points and mapping parameters required to obtain an output gamut having a shape similar to a shape of an input gamut of an input color space on the basis of information of the input color space and information of the output gamut; and
generating a mapping output gamut used in color conversion using the mapping points and mapping parameters.

2. The method according to claim 1, further comprising the step of acquiring hue information of a color coordinate system that indicates a distribution of colors at equal intervals of human visual perception so as to determine the mapping points corresponding to sample points on a line that connects a white point—a predetermined color point—black point of the input gamut.

3. The method according to claim 1, further comprising the step of generating a color conversion profile on the basis of the mapping output gamut.

4. The method according to claim 3, further comprising the step of conducting color conversion using the profile.

5. The method according to claim 1, further comprising the step of selecting an algorithm for generating the mapping points and mapping parameters from a plurality of algorithms, which are set in advance, on the basis of the information of the input color space.

6. A color processing apparatus to convert an input signal into an output color signal, comprising:
a determiner, arranged to determine mapping points and mapping parameters required to obtain an output gamut having a shape similar to a shape of an input gamut of an input color space on the basis of information of the input color space and information of the output gamut; and
a generator, arranged to generate a mapping output gamut used in color conversion using the mapping points and mapping parameters.

7. The apparatus according to claim 6, further comprising a memory arranged to store hue information of a color coordinate system that indicates a distribution of colors at equal intervals of human visual perception so as to generate the mapping points corresponding to sample points on a line that connects a white point—a predetermined color point—black point of the input gamut.

8. A computer program product storing a computer readable medium having a computer program code, for a color processing method to convert an input color signal into an output color signal, the product comprising process procedure codes for:
determining mapping points and mapping parameters required to obtain an output gamut having a shape similar to a shape of an input gamut of an input color space on the basis of information of the input color space and information of the output gamut; and
generating a mapping output gamut used in color conversion using the mapping points and mapping parameters.

9. The product according to claim 8, further comprising a process procedure code for acquiring hue information of a color coordinate system that indicates a distribution of colors at equal intervals of human visual perception so as to determine the mapping points corresponding to sample points on a line that connects a white point—a predetermined color point—black point of the input gamut.

10. A color processing method to convert an input signal into an output color signal, comprising the steps of:
determining mapping points and mapping parameters required to obtain an output gamut having a shape similar to a shape of an input gamut of an input color space on the basis of information of the input color space and information of the output gamut;
generating a mapping output gamut used in color conversion using the mapping point and mapping parameters;
forming a color conversion profile on the basis of the mapping output gamut;
evaluating a color conversion result of a predetermined evaluation color using the profile; and
correcting the mapping points within a predetermined range on the basis of the evaluation result, and re-executing generation of the mapping output gamut and generation of the profile.

11. The method according to claim 10, further comprising the step of acquiring data indicating the evaluation color.

12. The method according to claim 11, further comprising the step of acquiring data indicating a target color after color conversion and an allowable range thereof corresponding to the data indicating the evaluation color, wherein the evaluation is made on the basis of the data indicating the target color after color conversion and the allowable range thereof.

13. The method according to claim 10, further comprising the step of acquiring data indicating a correction range of the mapping points.

14. The method according to claim 12, wherein the correction range of the mapping points indicates a correction range of hue.

15. A color processing apparatus to convert an input signal into an output color signal, comprising:
a determiner, arranged to determine mapping points and mapping parameters required to obtain an output gamut having a shape similar to a shape of an input gamut of an input color space on the basis of information of the input color space and information of the output gamut;
a generator, arranged to generate a mapping output gamut used in color conversion using the mapping point and mapping parameters;
a former, arranged to form a color conversion profile on the basis of the mapping output gamut;
an evaluation section, arranged to evaluate a color conversion result of a predetermined evaluation color using the profile; and
a controller, arranged to correct the mapping points within a predetermined range on the basis of the evaluation result, and re-execute generation of the mapping output gamut and generation of the profile.

16. A computer program product storing a computer readable medium having a computer program code, for a color processing method to convert an input color signal into an output color signal, the product comprising process procedure codes for:
determining mapping points and mapping parameters required to obtain an output gamut having a shape similar to a shape of an input gamut of an input color space on the basis of information of the input color space and information of the output gamut;
generating a mapping output gamut used in color conversion using the mapping point and mapping parameters;
forming a color conversion profile on the basis of the mapping output gamut;
evaluating a color conversion result of a predetermined evaluation color using the profile; and
correcting the mapping points within a predetermined range on the basis of the evaluation result, and re-executing generation of the mapping output gamut and generation of the profile.

17. A color processing method to convert an input signal into an output color signal, comprising the steps of:
acquiring regional information indicating an observation environment of an output image;
acquiring information associated with color spaces of image input and output devices;
generating color processing parameters on the basis of the regional information and information associated with the color space; and
forming a profile used to convert an input color signal into an output color signal using the generated color processing parameters.

18. The method according to claim 17, further comprising the step of acquiring an image design parameter corresponding to the regional information.

19. The method according to claim 18, wherein the image design parameter is acquired from a memory that stores a plurality of image design parameters corresponding to a plurality of pieces of regional information.

20. The method according to claim 17, wherein the color processing parameters include conversion information of an arbitrary color value or tone characteristic conversion information between two arbitrary color values.

21. The method according to claim 17, wherein the regional information is acquired from the image output device or the image input device.

22. The method according to claim 17, wherein the regional information is acquired from a user's input.

23. The method according to claim 17, wherein the regional information is acquired from a device for acquiring position information.

24. The method according to claim 17, wherein the regional information is acquired from a host computer.

25. A color processing method to convert an input signal into an output color signal, comprising the steps of:
a first obtaining section, arranged to acquire regional information indicating an observation environment of an output image;
a second obtaining section, arranged to acquire information associated with color spaces of image input and output devices;
a generator, arranged to generate color processing parameters on the basis of the regional information and information associated with the color space; and
a former, arranged to form a profile used to convert an input color signal into an output color signal using the generated color processing parameters.

26. A computer program product storing a computer readable medium having a computer program code, for a color processing method to convert an input color signal into an output color signal, the product comprising process procedure codes for:
acquiring regional information indicating an observation environment of an output image;
acquiring information associated with color spaces of image input and output devices;
generating color processing parameters on the basis of the regional information and information associated with the color space; and
forming a profile used to convert an input color signal into an output color signal using the generated color processing parameters.

27. A color processing method of performing a color conversion to convert an input signal into an output color signal, comprising the steps of:
determining mapping points and mapping parameters required to obtain similar color appearances by human visible perception from different output media, wherein shapes of gamut of the media are different from each other; and
mapping the gamut to output gamut by using the determined mapping points and mapping parameters to perform the color conversion.
